(19) United States
(12) Patent Application Publication
(10) Pub. No.: US 2006/0111653 A1
(43) Pub. Date: May 25, 2006

(54) Massager

(75) Inventors: Fumihiro Nishio, Hikone-shi (JP); Masamichi Miyaguchi, Hikone-shi (JP); Daisuke Tsukada, Hikone-shi (JP); Takeo Iijima, Hikone-shi (JP); Yousuke Kurata, Hikone-shi (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 11/286,349

(22) Filed: Nov. 25, 2005

(30) Foreign Application Priority Data
Nov. 25, 2004 (JP) 2004-340022

(51) Int. Cl. A61H 7/00

(52) U.S. Cl. 601/84

(57) ABSTRACT

In a massager having a pair of medical treating members, a distance between the medical treating in medical treatment such as tapping or backstretch, except massaging can be varied corresponding to rotation angle of a driving shaft. A distance detector comprises a rotation disc rotated with the rotation of the driving shaft and having at least two apertures formed along the same circle, and an optical detector for detecting edged of the apertures in circumferential direction of the rotation disc. At least three edges of the aperture are homologized to at least three stages of the distances between the medical treating members, so that the distances between the medical treating members can be adjusted by monitoring output signal of the optical detectors.

### BACKGROUND OF THE INVENTION

1. Field of the Invention

The present invention relates to a massager with a simple configuration which can detect and control a distance between a pair of medical treating members such as massage balls.

2. Description of the Related Art

A massager having a pair of medical treating members such as massage balls movably provided in a medical treatment table such as a backrest of a chair or a bed performs medical treatment such as back stretching, shoulder tapping, shiatsu (finger pressure), massaging or vibrating to a person to be treated so as to alleviate the tension in the shoulders of the person to be treated or to relax the person to be treated. The medical treatment is necessary to be performed at predetermined portions such as trigger points of the person to be treated so as to increase massaging effect. However, portions to be stimulated of a person to be treated are scattered around, and physical frame varies by an individual person to be treated. Thus, a distance between a pair of medical treating members should be varied.

A massager, which drives a pair of medical treating members in a predetermined medical treating motion, generally comprises a distance detector for detecting a distance between the medical treating members or detecting positions of the medical treating members in widthwise direction and a distance adjuster for adjusting the distance between the medical treating members or adjusting positions of the medical treating members in the widthwise direction. Although the distance adjuster can be provided as an independent mechanism from a massaging mechanism of the medical treating members, it causes the complexity of the mechanisms, upsizing and heavy-weighting of the massager.

Therefore, a conventional massager, for example shown in Japanese Laid-Open Patent Publication No. 7-289600 comprises a distance adjusting mechanism utilizing a massaging motion of the medical treating members. FIG. 11A shows a configuration of a massaging mechanism of the conventional massager, and FIG. 11B shows a massaging mechanism for driving the medical treating members.

As can be seen from FIG. 11A, the massaging mechanism M comprises a motor unit 120 including a motor and a reduction unit 119 including a reduction mechanism for reducing rotation speed of the motor. The motor unit 120 is provided in a side and the reduction unit 119 is provided in the opposite side of the massager in widthwise direction. A main shaft 101 and a sub shaft 113 are provided between the motor unit 120 and the reduction unit 119. Rollers 118 which roll on rails provided in an inside of a medical treating table and pinion gears 117 engaging with rack gears provided on the rails are provided to be protruded outward from the motor unit 120 and the reduction unit 119.

The motor included in the motor unit 120 serves as a driving source of entire of this massaging mechanism M, so that it rotated the main shaft 101 and the pinion gears 117. Specifically, a pulley 128 is fixed on an output shaft of the motor protruded downward from the motor unit 120, and a belt 129 is coupled with the pulley 128. The belt 129 is further coupled with a pulley 130 fixed on a driven shaft 131 which is provided in an outer face of the reduction unit 119. The driven shaft 131 is coupled to the reduction mechanism in the reduction unit 119 through a pulley 134 fixed on the driven shaft 131, a belt 135 and a pulley 136 fixed on an input shaft of the reduction mechanism. The reduction mechanism comprises reduction gears and a plurality of clutches, so that it can selectively output the driving force of the motor to the main shaft 101 and the pinion gears 117.

Further referring to FIG. 11B, a pair of inner wheels 102 are fixed on the main shaft 101 with a predetermined distance. The inner wheels 102 are respectively decentered with the same quantity in the same direction but inclined in the opposite directions. Since the inner wheels 102 are fixed on the main shaft 101 by engaging with a square bar 111, the inner wheels 102 rotate with the main shaft 101. A pair of outer wheels 103 is freely rotatably attached to outer faces of the inner wheels 102. The outer wheels 103 are respectively fixed to mid portions of arms 104, and a pair of roller shaped medical treating members 105 are fixed on flexions at front ends of the arms 104 so that the medical treating members 105 can rotated freely with respect to the arms 104. The other ends of the arms 104 are respectively coupled with links 108.

By such a massaging mechanism, since the inner wheels 102 are decentered and inclined with respect to the main shaft 101, the medical treating members 105 are coupled with the inner wheels 103 freely movable with respect to the inner wheels 102 via the arms 104, and the motion of the arms 104 are restricted by the links 108, when the main shaft 101 is rotated by the motor, the motion of the medical treating members 105 draw three-dimensional locus shown by arrows T in FIG. 11B.

According to the rotation quantity (or rotation angle) of the main shaft 101, relative positions of the medical treating members 105 in the widthwise direction vary, so that the distance between the medical treating members 105 is varied. Although the distance between the medical treating members 105 or relative positions of the medical treating members 105 in the widthwise direction cannot be adjusted for massaging operation, it is possible to adjust the distance between the medical treating members 105 for medical treatment such as back stretching, shoulder tapping, shiatsu (finger pressure), or vibrating with using the change of the distance between the medical treating members 105 while the massaging operation corresponding to the portions to be stimulated or physical frame of a person to be treated. In other words, the medical treating members 105 can be moved from positions, for example, illustrated by solid lines in FIG. 11A where the distance between the medical treating members 105 is the narrowest to positions illustrated by two dotted chain lines where the distance between the medical treating members 105 is widest by caracoling the main shaft 101. Thus, by adjusting the rotation quantity or rotation angle of the main shaft 101, it is possible to adjust the distance between the medical treating members 105. In addition, it is easily found that the inner wheels 102 are not necessarily decentered with respect to the main shaft 101 for adjusting the distance between the medical treating members 105, but it is sufficient that the inner wheels 102 are inclined with respect to the main shaft 101 in opposite directions.

In this way, since the distance between the medical treating members 105 is changed corresponding to the rotation of the main shaft 101, it is sufficient to rotate the main shaft 101 by a purposed angle corresponding to an intended distance between the medical treating members 105 from a reference position of the main shaft 101. Thereby, a distance detection unit 200 for detecting a distance between the medical treating members 105, in other words, a rotation angle of the main shaft 101 which is illustrated by dotted lines in FIG. 11B is provided in the massaging mechanism M.

Detailed configuration of the distance detection unit 200 is described with reference to FIGS. 11B, 12A to 12C, 13A and 13B. FIG. 12A is a perspective view showing a configuration of the distance detection unit 200. FIG. 12B is a front view of a rotation disc 201 of the distance detection unit 200. FIG. 12C is a schematic diagram showing the distance between the medical treating members 105. FIG. 13A is a timing chart showing on and off of the motor and outputs of first and second detectors of the distance detection unit 200. FIG. 13B is a table showing relations between positions on the rotation disc 201 and the outputs of the first and second detectors of the distance detection unit 200.

As can be seen from figures, the distance detection unit 200 comprises a rotation disc 201, a detector unit 202 and a circuit board 203. The rotation disc 201 is fixed on the main shaft 101 so that a rotation center of the rotation disc 201 coincides with a center axis of the main shaft 101. In other words, the rotation disc 201 rotates simultaneously with the rotation of the inner wheels 102. The rotation disc 201 has a first aperture 2011 and a second aperture 2012 which are independently formed. The first aperture 2011 is an arc shaped opening having a width W in radial direction of the rotation disc 201 formed along a circle having a radius of “r1” from the center O. The second aperture 2012 is an arc shaped opening having a width W in the radial direction of the rotation disc 201 formed along a circle having a radius of “r2” from the center O. Since the radius “r1” is larger than a sum of the radius “r2” and the width “W” (r1>r2+W), the second aperture 2012 is formed to be overlapped with a part of the first aperture 2011 in circumferential direction of the rotation disc 201.

The detector unit 202 comprises two pairs of an LED (Light Emitting Diode) 2021-1 and 2021-2 and a photodiode 2022-1 and 2022-2 each constituting a transmission photo-interrupter. The LEDs 2021-1 and 2021-2 and the photodiodes 2022-1 and 2022-2 are mounted on the circuit board 203. The LED 2021-1 and the photodiode 2022-1 are disposed for facing the first aperture 2011 so as to serve as the first detector. The LED 2021-2 and the photodiode 2022-2 are disposed for facing the second aperture 2012 so as to serve as the second detector. An output of the first detector varies when it detects edges of the first aperture 2011 and an output of the second detector varies when it detects edges of the second aperture 2012 corresponding to the rotation of the rotation disc 201.

When the motor is switched on, the main shaft 101 starts to rotate with the inner wheels 102 and the rotation disc 201, for example in the counterclockwise direction shown by arrow CW in FIG. 12B. When the front edge P1 of the first aperture 2011 shown in FIG. 12B reaches to a position facing the LED 2021-1 of the first detector at a time TP1 shown in FIG. 13A, light emitted from the LED 2021-1 reaches to the photodiode 2022-1 through the first aperture 2011, so that the photodiode 2022-1 generates a photoelectric current corresponding to quantity of received light. The photoelectric current is converted to voltage by a resistor, and the voltage is outputted as an output signal of the first detector of the detector unit 202. That is, the output signal from the first detector varies from low level “0” to high level “1” at the time TP1.

When the rotation disc 202 further rotates and the front edge P2 of the second aperture reaches to a position facing the LED 2021-2 of the second detector at a time TP2, the output signal from the second detector varies from low level “0” to high level “1” at the time TP2.

When the rotation disc 202 still further rotates and the rear edge P3 of the first aperture 2011 reaches to a position facing the LED 2021-1 of the first detector at a time TP3, light emitted from the LED 2021-1 is shielded by the rotation disc 201 and cannot reach to the photodiode 2022-1, so that the photodiode 2022-1 outputs no photoelectric current. Thus, the output signal from the first detector varies from high level “1” to low level “0” at the time TP3.

When the rotation disc 202 still further rotates and the rear edge P4 of the second aperture reaches to a position facing the LED 2021-2 of the second detector at a time TP4, the output signal from the second detector varies from high level “1” to low level “0” at the time TP4.

When the rotation disc 201 still further rotates and the front edge P1 of the first aperture 2011 reaches to the position facing the LED 2021-1 of the first detector, the above-mentioned motions are repeated.

Therefore, relations between the edges P1 to P4 of the first and second apertures 2011 and 2012 of the rotation disc 201 and the output signals from the first and second detectors can be written in the table shown in FIG. 13B. When the output of the first detector is high level “1” and the output of the second detector is low level “0”, the rotation disc 201 is in a state that the first and second detectors face a portion between the edges P1 and P2 of the rotation disc 201. When the output of the first detector is high level “1” and the output of the second detector is high level “1”, the rotation disc 201 is in a state that the first and second detectors face a portion between the edges P2 and P3 of the rotation disc 201. When the output of the first detector is low level “0” and the output of the second detector is high level “1”, the rotation disc 201 is in a state that the first and second detectors face a portion between the edges P3 and P4 of the rotation disc 201. When the output of the first detector is low level “0” and the output of the second detector is low level “0”, the rotation disc 201 is in a state that the first and second detectors face a portion between the edges P4 and P1 of the rotation disc 201.

Thereby, the rotation angle or position of the rotation disc 201 can be detected roughly from the combination of the output signals of the first and second detectors. By selecting the positions and lengths in the circumferential direction of the first and second apertures 2011 and 2012 on the rotation disc 201 preferably, it is possible that the positions P1 to P4 on the rotation disc 201 correspond to the distances between the medical treating members 105. Consequently, the distance between the medical treating members 105 can be detected by the distance detection unit 200.

For example, it is assumed that a state of the largest distance W1 between the medical treating members 105 shown by two dotted chain lines in FIG. 12C is corresponded to the position P1 of the rotation disc 201, a state of the smallest distance W3 between the medical treating members 105 shown by dotted lines is corresponded to the position P4 of the rotation disc 201, and a state of a middle distance W2 between the medical treating members 105 shown by solid lines in FIG. 12C is corresponded to the position P2 of the rotation disc 201. Since the medical treating members 105 shift from the state of the largest distance W1 to the state of the smallest distance W3 by caracoling the main shaft 101, the front edge P1 of the first aperture 2011 and the rear edge P4 of the second aperture 2012 are located on the same line passing through the center O.

As mentioned above, the distance detection unit 200 of the conventional massager needs to provide two sets of the LEDs 2021-1 and 2021-2 and the photodiodes 2022-1 and 2022-2 and to form two apertures 2011 and 2012 on the rotation disc 201 independently for detecting three stages of the widest, middle and narrower distances between the medical treating members 105. Thus, the distance detection unit 200 becomes expensive. Furthermore, since the positional relation between the first aperture 2011 of the rotation disc 201 and the LED 2021-1 and the photodiode 2022-1 and the positional relation between the second aperture 2012 and the LED 2021-2 and the photodiode 2022-2 must be satisfied simultaneously, the adjustment of the positions of the rotation disc 201 on the main shaft 101 with respect to the first and second detectors of the distance detection unit 200 becomes complex, difficult and troublesome. Still furthermore, since a part of the first aperture 2011 and the second aperture 2012 are overlapped in the circumferential direction of the rotation disc 201, the radius “r1” of the first aperture 2011 must be larger than the sum of the radius r2 and the width “W” of the second aperture 2012. Thus, the radius of the rotation disc 201 becomes larger, so that the miniaturization of the distance detection unit 200 is restricted by the size of the rotation disc 201. Still furthermore, the distance detection unit 200 configured above is sufficient to detect the distance between the medical treating members 105 at four stages. If the distance between the medical treating members 105 is detected at more than five stages, it is necessary to form a third aperture having a different radius on the rotation disc 201 and to provide one more set of the LED and the photodiode. Thus, it is practically impossible to modify the distance detection unit 200 to detect the distance between the medical treating members 105 at more than five stages.

### SUMMARY OF THE INVENTION

The present invention is contrived to solve the above-mentioned problems on the conventional massager, and a purpose of the present invention is to provide a massager with a simple configuration which can detect a distance between a pair of medical treating members at more than three stages.

A massager in accordance with an aspect of the present invention comprises a pair of medical treating members, a motor for generating a driving force, a converting mechanism for converting rotation of a shaft of the motor to a motion for varying a distance between the medical treating members, a distance detector for detecting the distance between the medical treating members, and a distance controller for controlling the distance between the medical treating members among at least three stages.

The distance detector is comprised of a rotation disc which is rotated with a driving shaft of the converting mechanism and has at least two arc shaped sensing areas formed along a same circle having a predetermined radius from a rotation center of the disc, and an optical detector provided for facing the rotation disc for detecting passage of edges of the sensing areas in circumferential direction of the rotation of the rotation disc and for outputting detection signals corresponding to detection of the edges of the sensing areas.

The sensing areas are formed so that at least one sensing area has a length in the circumferential direction different from that of another sensing area so as to be distinguished from others, and at least three edges of the sensing areas in the circumferential direction of the rotation disc are homologized to at least three stages of different distances of the medical treating members.

The distance controller drives the motor so that the distance detector detects an edge of the sensing areas among the above at least three edges when one among the above at least three stages of different distances of the medical treating members is selected.

By such a configuration, since at least two sensing areas are formed on the rotation disc, at least three rotation angles of the rotation disc can detected by detecting the edges of the sensing areas. Furthermore, since the rotation disc is rotated with the driving shaft of the converting mechanism, it is possible to homologize the positions of the edges of the sensing areas to the predetermined rotation angles of the driving shaft. The distance between the medical treating members is varied corresponding to rotation angle of the driving shaft, so that it is possible to detect the distance between the medical treating members by homologizing the rotation angle of the rotation member. In other words, the distance between the medical treating members can be adjusted by monitoring the output signal from the distance detector while driving the motor.

Furthermore, since the sensing areas are formed on the same circle, the radius of the rotation disc can be made smaller in comparison with the conventional one having two arc shaped apertures serving as sensing areas formed along different circles having different radiuses. Still furthermore, the distance detector needs only one set of the optical detector such as a photo-interrupter including one light emitting device and one light receiving device. Thus, the configuration of the distance detector becomes simple and the cost thereof can be reduced.

In the above-mentioned massager, it is preferable that the distance between the medical treating members are varied from a largest state to a smallest state by caracoling the driving shaft; two edges of the sensing areas are disposed on a same line passing the rotation center of the rotation disc; and one of the above two edges of the sensing areas is homologized to the largest state of the distance between the medical treating members and the other of the above two edges of the sensing areas is homologized to the smallest state of the distance between the medical treating members.

Furthermore, it is preferable that the optical detector is a transmission type photo-interrupter, the rotation disc is made of non-transparent material and arc shaped apertures are formed on the rotation disc as the sensing areas.

Alternatively, it is preferable that the optical detector is a transmission type photo-interrupter; the rotation disc is made of transparent material and a surface of the rotation disc except the sensing areas are coated by non-transparent material.

Alternatively, it is preferable that the optical detector is a reflection type photo-interrupter, the rotation disc is formed of a non-transparent material, and portions corresponding to the sensing areas are coated by a material having a reflectance higher than that of the non-transparent material.

Still furthermore, it is preferable that the rotation disc is rotated in a same direction at any time while the distance of the medical treating members is adjusted.

Still furthermore, it is preferable that the rotation disc is rotated in a same rotation speed at any time while the distance of the medical treating members is adjusted.

On the other hand, a massager in accordance with another aspect of the present invention comprises a pair of medical treating members, a motor for generating a driving force, a converting mechanism for converting rotation of a shaft of the motor to a motion for varying a distance between the medical treating members, a distance detector for detecting the distance between the medical treating members, and a distance controller for controlling the distance between the medical treating members among at least three stages.

The distance detector is comprised of a rotation disc which is rotated with a driving shaft of the converting mechanism and has an arc shaped sensing area formed along a circle having a predetermined radius from a rotation center of the disc, and an optical detector provided for facing the rotation disc for detecting passage of edges of the sensing area in circumferential direction of the rotation of the rotation disc and for outputting detection signals corresponding to detection of the edges of the sensing areas.

The sensing area is formed so that an edge of the sensing areas in the circumferential direction is homologized to a predetermined distance of the medical treating members.

The distance controller estimate rotation angle of the rotation disc based on a term after the distance detector detects the edge of the sensing areas homologized to the predetermined distance of the medical treating members, and drives the motor to stop when a predetermined term corresponding to a selected distance of the medical treating members selected has passed.

By such a configuration, since the rotation disc is rotated with the driving shaft of the converting mechanism, it is possible to homologize the position of one edge of the sensing area to the predetermined rotation angle of the driving shaft, as a reference position. The distance between the medical treating members is varied corresponding to rotation angle of the driving shaft, so that it is possible to estimate the distance between the medical treating members by homologizing the rotation angle of the rotation member. In other words, the distance between the medical treating members can be adjusted by monitoring the output signal from the distance detector while driving the motor.

Furthermore, since only one sensing area is formed on the rotation disc, the radius of the rotation disc can be made smaller in comparison with the conventional one having two arc shaped apertures serving as sensing areas formed along different circles having different radiuses. Still furthermore, the distance detector needs only one set of the optical detector such as a photo-interrupter including one light emitting device and one light receiving device. Thus, the configuration of the distance detector becomes simple and the cost thereof can be reduced.

In the above-mentioned massager, it is preferable that the optical detector is a transmission type photo-interrupter, the rotation disc is made of non-transparent material and arc shaped apertures are formed on the rotation disc as the sensing areas.

Furthermore, it is preferable that the optical detector is a transmission type photo-interrupter; the rotation disc is made of transparent material and a surface of the rotation disc except the sensing areas are coated by non-transparent material.

Still furthermore, it is preferable that the optical detector is a reflection type photo-interrupter, the rotation disc is formed of a non-transparent material, and portions corresponding to the sensing areas are coated by a material having a reflectance higher than that of the non-transparent material.

### BRIEF DESCRIPTION OF THE DRAWINGS

FIG. 1 is a perspective view showing an appearance of a massager in accordance with a first embodiment of the present invention;

FIG. 2 is block diagram showing an electric configuration of the massager in accordance with the first embodiment;

FIG. 3A is an anterior perspective view showing a configuration of a massaging mechanism of the massager in accordance with the first embodiment;

FIG. 3B is a top view showing the configuration of the massaging mechanism in the first embodiment;

FIG. 3C is a rear perspective view showing the configuration of the massaging mechanism in the first embodiment;

FIG. 4A is a perspective view showing a configuration of a distance detection unit of the massager in accordance with the first embodiment;

FIG. 4B is a front view showing a configuration of a rotation disc used in the distance detection unit in the first embodiment;

FIG. 4C is a block diagram showing a block configuration of a distance controller of the massager in the first embodiment;

FIG. 5 is a timing chart showing on and off of the motor and variation of output signal from a detector of the distance detection unit in the first embodiment;

FIG. 6 is a flowchart showing an operation of the distance controller in the first embodiment;

FIG. 7A is a front view showing a configuration on a rotation disc of a distance detection unit in a modified example of the first embodiment;

FIG. 7B is a timing chart showing on and off of the motor and variation of output signal from a detector of the distance detection unit in the modified example;

FIG. 7C is a block diagram showing a block configuration of a distance controller of the massager in the modified example of the first embodiment;

FIG. 8 is a flowchart showing an operation of the distance controller in the modified example of the first embodiment;

FIG. 9A is a perspective view showing a configuration of a distance detection unit of a massager in accordance with a second embodiment;

FIG. 9B is a front view showing a configuration of a rotation disc used in the distance detection unit in the second embodiment;

FIG. 9C is a block diagram showing a block configuration of a distance controller of the massager in the second embodiment;

FIG. 10 is a flowchart showing an operation of the distance controller in the second embodiment;

FIG. 11A is a perspective view showing a configuration of a massaging mechanism of a conventional massager;

FIG. 11B is a sectional view showing a configuration of a pair of medical treating members of the conventional massager;

FIG. 12A is a perspective view showing a configuration of a distance detection unit of the conventional massager;

FIG. 12B is a front view showing a configuration of a rotation disc used in the distance detection unit of the conventional massager;

FIG. 12C is a schematic diagram showing distances between a pair of medical treating members of the massager;

FIG. 13A is a timing chart showing on and off of a motor and variations of output signals of two detectors of the distance detection unit of the conventional massager; and

FIG. 13B is a table showing relations between combination of output levels of two detectors of the distance detection unit and positions of the rotation disc in the conventional massager.

### DETAILED DESCRIPTION OF THE EMBODIMENTS

### First Embodiment

A massager in accordance with a first embodiment of the present invention is described with reference to figures.

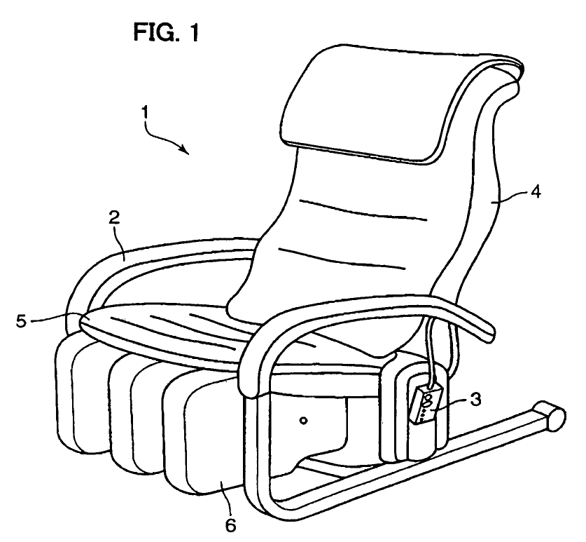

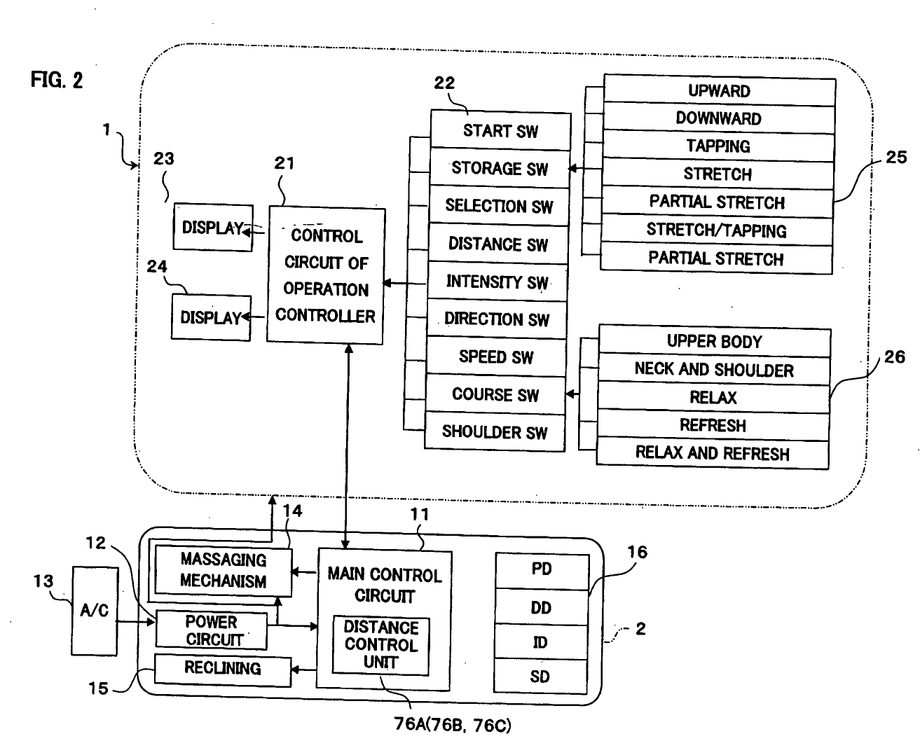

FIG. 1 shows an appearance of a massager 1 in accordance with the first embodiment. FIG. 2 shows an electric block configuration of the massager 1.

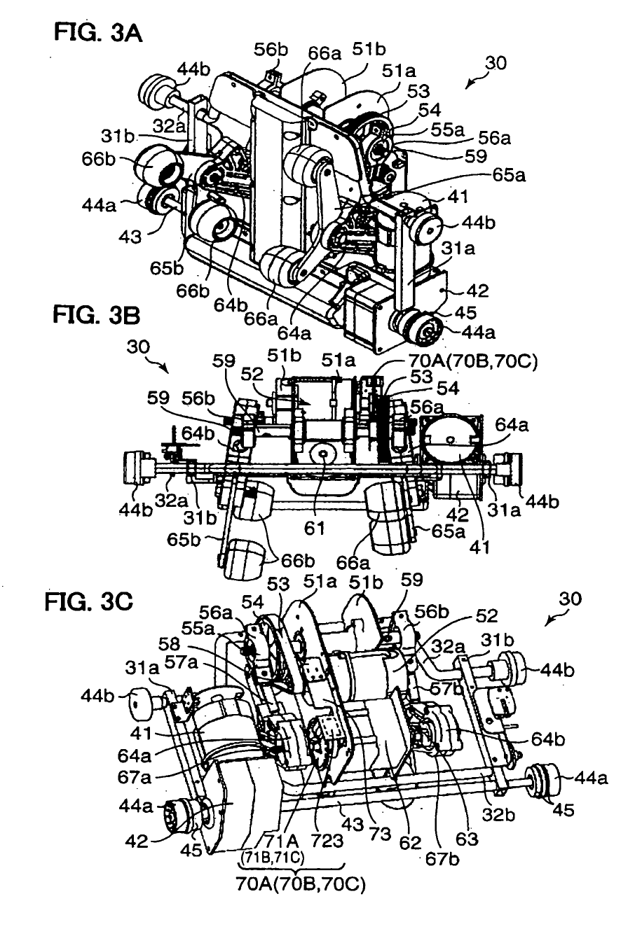

As shown in FIG. 1, the massager 1 has a reclining chair 2 on which various massaging treatment are performed to a person to be treated, and an operation controller 3 used for inputting various operation to a massaging mechanism 14 (referring to FIG. 2). The massaging mechanism 14 includes a first massaging mechanism 30 (referring to FIGS. 3A to 3C) for a pair of medical treating members and a second massaging mechanism for an air bag (not shown in the figure). The first massaging mechanism of the medical treating members is constituted to perform various massaging treatment to a person to be treated by motion of the medical treating members such as massage balls. The medical treating members are built in a backrest 4, and the positions of the medical treating members in horizontal direction and in vertical direction, moving speed of the medical treating members, and pressing force of the medical treating members to a body of a person to be treated, and motion of the medical treating members can be varied. On the other hand, the second massaging mechanism of the air bag is constituted to perform massaging treatment by expansion and contraction of the air bag. The air bag is provided, for example, in a seat 5 of the chair 2 and/or a footrest 6 which is to be disposed in lower front of the seat 5.

The operation controller 3 is individually provided from the reclining chair 2 and operable by a user. A control circuit 21 of the operation controller 3 and a main controller 11 of the massager 1 built-in the chair 2 are connected by a cable so as to be communicated each other. An electric power converted from a commercial power source 13 by a power supply circuit 12 in the chair 2 is supplied to circuits in the operation controller 3. In addition, the communication between the control circuit 21 of the operation controller 3 and the main control circuit 11 of the massager 1 can be performed by wireless communication. In such a case, electric power of the circuits in the operation controller 3 are supplied from a battery.

As shown in FIG. 2, the operation controller 3 is comprised of a plurality of switches 22 used for selecting an operation or for changing various preset values, and so on, a display devices 23 and 24 such as LCDs (Liquid Crystal Display devices) for displaying various information such as selected operation mode, positions of the medical treating members, and so on, and the control circuit 21 configured by a microprocessor, and so on for communicating various data with the main controller 11 of the massager 1 built-in the chair 2.

The switches 22 includes an operation stat switch (START SW) used for starting massaging treatment in various mode, a storage switch (STORAGE SW) used for storing, for example, the medical treating members to initial positions after completing the massaging treatment, an operation selection switch (SELECTION SW) used for selecting a motion of the medical treating members, a distance adjusting switch (DISTANCE SW) used for adjusting a distance between the medical treating members in horizontal direction, an intensity adjusting switch (INTENSITY SW) used for adjusting an intensity of pressing force applied to a body of a person to be treated by the medical treating members, a direction selecting switch (DIRECTION SW) used for selecting a moving direction of the medical treating members in vertical direction, a speed control switch (SPEED SW) used for varying a moving speed of the medical treating members, a course selection switch (COURSE SW) used for selecting a course among a plurality of automatic operation courses of combination medical treatments, and a shoulder position adjusting switch (SHOULDER SW) used for adjusting positions of the medical treating members with respect to a shoulder position of the person to be treated.

When a user selects a motion of the medical treating members by operating the motion selection switch and operates the operation start switch, the motions of the medical treating members are started with a distance between the medical treating members with using the distance adjusting switch or previously set, with an intensity of pressing force of the medical treating members set with using the intensity adjusting switch or previously set, in a moving speed of the medical treating members set with using the speed control switch or previously set, and in a direction set with using the direction selecting switch or previously set. As for the motion of the medical treating members (kind of medical treatment), massaging upward (UPWARD), massaging downward (DOWNWARD), tapping (TAPPING), back stretching (STRETCH), partial back stretching (PARTIAL STRETCH), back stretching with shoulder tapping (STRETCH/TAPPING), partial back stretching with shoulder tapping, and so on are enumerated as shown by reference numeral 25 in FIG. 2.

Alternatively, when the user select a course among a plurality of the automatic course by operating the course selection switch instead of selecting an individual motion by operating the motion selection switch, and operates the operation start switch, the motions of the medical treating members are started following to a program corresponding to the selected course with a distance between the medical treating members set with using the distance adjusting switch or previously set, and with an intensity of pressing force of the medical treating members set with using the intensity adjusting switch or previously set. As for the automatic course, upper body course (UPPER BODY), neck and shoulder course (NECK AND SHOULDER), relax course (RELAX), refresh course (REFRESH), relax and refresh course (RELAX AND REFRESH), and so on are enumerated as shown by reference numeral 26 in FIG. 2.

On the other hand, the above-mentioned massaging mechanism 14, the main controller 11 constituted by, for example, a microprocessor, and so on, and driving the massaging mechanism 14 and a reclining mechanism 15 for lifting up and down the massaging mechanism 14 responding to control command from the control circuit 21 of the operation controller 3, the power supply circuit 12, and a plurality of detectors 16 including a position detector (PD) for sensing the positions of the medical treating members in vertical direction, a distance detector (DD) for sensing a distance between the medical treating members or positions of the medical treating members in horizontal direction, an intensity detector (ID) for sensing the intensity of the pressing force by the medical treating members or the air bag, and a speed detector (SD) for sensing moving speed of the medical treating members or operation speed of the air bag, and so on.

Subsequently, a specific configuration of the above-mentioned first massaging mechanism 30 for a pair of medical treating members (hereinafter, abbreviated as massaging mechanism 30) is described in detail. FIGS. 3A, 3B and 3C are respectively an anterior perspective view, a top view and a rear perspective view of the massaging mechanism 30.

The massaging mechanism 30 is installed between a pair of frames provided in vertical direction in an inside of the backrest 4. The massaging mechanism 30 comprises a pair of vertical frames 31a and 31b made of hollow rectangular pipes and vertically disposed on both sides in horizontal direction, an upper horizontal frame 32a made of a hollow circular pipe and a center portion thereof being inflected, and a lower horizontal frame 32b made of a hollow circular pipe and an end thereof being inflected so as not to interfere a lifting reduction unit 42 for moving up and down of the massaging mechanism 30. Both ends of the upper horizontal frame 32a are respectively fixed on, for example upper ends of the vertical frames 31a and 31b so as to penetrate the vertical frames 31a and 31b outward. Both ends of the lower horizontal frame 32b are respectively fixed on the other ends of the vertical frames 31a and 31b.

The lifting reduction unit 42 including a reduction mechanism is fixed on the vertical frame 31a. A lifting motor 41 used for moving up and down the massaging mechanism 30 is fixed on the lifting reduction unit 42 so that an output shaft of the lifting motor 41 is engaged with the reduction mechanism in the lifting reduction unit 42. The lifting reduction unit 42 comprises a lifting shaft 43 for moving up and down, and a pair of rollers 44a and a pair of pinion gears 45 are provided on both ends of the lifting shaft 43. The rollers 44a roll on a pair of rails respectively provided on both sides in the inside of the backrest 4 in horizontal direction, and the pinion gears 45 engage with racks respectively provided on the rails. A pair of rollers 44b rolling on the rails are further provided on both sides of the upper horizontal frame 32a. Rotation speed of the output shaft of the lifting motor 41 is reduced by the reduction mechanism in the lifting reduction unit 42 and the rotation force of the lifting motor 41 increased by the reduction mechanism is transmitted to the lifting shaft 43.

By such a configuration, the massaging mechanism 30 is guided by the rails provided in heightwise direction in the backrest 4. When the lifting motor 41 is driven, the driving force of the lifting motor 41 is transmitted to the pinion gears 45 through the reduction mechanism in the lifting reduction unit 42 and the lifting shaft 43, so that the pinion gears 45 engaging with racks are rotated, thereby enabling up and down motion of the massaging mechanism 30 in the inside of the backrest 4.

A tapping motor 52 and a pair of supporting plates 51a and 51b for supporting a massaging reduction unit 62 are provided between the upper horizontal frame 32a and the lower horizontal frame 32b.

The massaging reduction unit 62 including a reduction mechanism is fixed between the supporting plates 51a and 51b, and comprises a massaging shaft 63 penetrating through the supporting plates 51a and 51b. A pair of massaging inner wheels 67a and 67b, which are decentered with the same quantity in the same direction and inclined in opposite directions with respect to the massaging shaft 63, is fixed on both ends of the massaging shaft 63. A pair of first arms 64a and 64b respectively comprising massaging outer wheels (not illustrated in FIGS. 3A to 3C) is provided on both ends of the massaging shaft 63 so that the massaging outer wheels are freely rotatably attached to outer faces of the massaging inner wheels 67a and 67b. A pair of second arms 65a and 65b having a substantially L-shape is fixed to ends of the first arms 64a and 64b at flexion of L-shape. A set of roller shaped medical treating members 66a is freely movably attached to both ends of the second arm 65a. Similarly, a set of roller shaped medical treating members 66b is freely movably attached to both ends of the second arm 65b.

The tapping motor 52 is held in a cutting portion having a substantially U-shaped and formed on one supporting plate 51b and fixed on the other supporting plate 51a so that an output shaft of the tapping motor 52 penetrates through a hole. A tapping shaft 59 is provided for penetrating the supporting plates 51a and 51b, and a pulley 54 is fixed on an end of the tapping shaft 59. A pulley 58 is fixed on an end of the output shaft of the tapping motor 52. A reduction belt 53 is provided between the pulleys 54 and 58. Since the diameter of the pulley 54 is larger than that of the pulley 58, the rotation speed of the tapping motor 52 is reduced. Furthermore, a pair of tapping inner wheels 55a and 55b (55b is not illustrated in FIGS. 3A to 3C), which are decentered with the same quantity in the same direction and inclined in opposite directions with respect to the tapping shaft 59, is fixed on both ends of the tapping shaft 59. A pair of tapping outer wheels 56a and 56b is freely rotatably attached to outer peripheral faces of the tapping inner wheels 55a and 55b. Ends of link bars 57a and 57b are respectively coupled to the tapping outer wheels 56a and 56b, and the other end of the link bars 57a and 57b are respectively rotatably coupled with center portions of the first arms 64a and 64b.

When the tapping motor 52 is driven, rotation force of the tapping motor 52 is transmitted to the tapping shaft 59 through the output shaft of the tapping motor 52, the pulley 58, the belt 53 and the pulley 54, so that the tapping shaft 59 is rotated. Since the tapping outer wheels 56a and 56b and the first arms 64a and 64b are linked by the link bars 57a and 57b, the motions of the tapping outer wheels 56a and 56b are restricted and not rotated. When the decentered tapping inner wheels 55a and 55b are rotated corresponding to the rotation of the tapping shaft 59, the rotation of the tapping shaft 59 is converted to swing motion of the tapping outer wheels 56a and 56b. Furthermore, the swing motion of the tapping outer wheels 56a and 56b are transmitted to the first arms 64a and 64b via the link bars 57a and 57b. Thus, the medical treating members 66a and 66b attached to ends of the second arms 65a and 65b which is further fixed to the first arms 64a and 64b are moved up and down like tapping treatment.

When the massaging motor 61 is driven, rotation force of the massaging motor 61 is transmitted to the massaging shaft 63 through the reduction mechanism in the reduction unit 62, so that the massaging shaft 63 is rotated. Since the massaging inner wheels 67a and 67b are decentered and inclined with respect to the massaging shaft 63, and the massaging outer wheels of the first arms 64a and 64b are freely rotatably attached to outer faces of the massaging inner wheels 67a and 67b, when the massaging shaft 63 is rotated, the first arms 64a and 64b are moved to trace a three-dimensional locus. Thus, the medical treating members 66a and 66b attached to ends of the second arms 65a and 65b which is further fixed to the first arms 64a and 64b are three-dimensionally moved to vary the positions thereof in vertical direction and in horizontal direction and to vary quantities of protrusion from the backrest 4 like massaging treatment.

It should be noted that the massaging mechanism 30 comprises a distance detection unit (distance detector) 70A for detecting a rotation angle of the massaging shaft 63, in other words, a distance between the medical treating members 66a and 66b, and the main control circuit 11 has a function of a distance control unit (distance controller) 76A for controlling the distance between the medical treating members 66a and 66b on the basis of an output from the distance detection unit 70A.

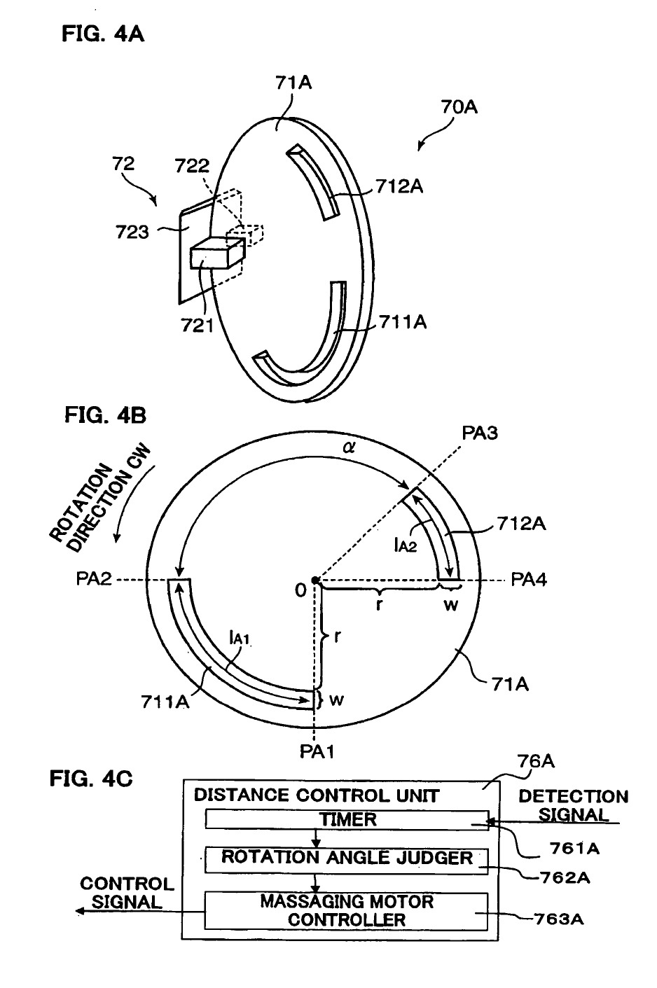

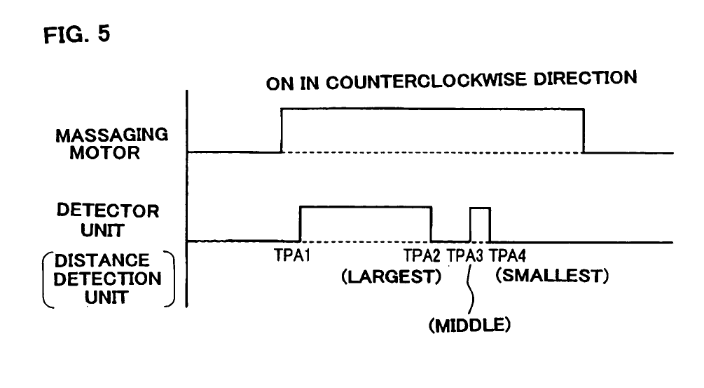

FIG. 4A shows a configuration of the distance detection unit 70A, and FIG. 4B shows a configuration of a rotation disc 71A constituting the distance detection unit 70A. FIG. 4C shows a block configuration of the distance control unit 76A. FIG. 5 shows timing of on and off of the massaging motor 61 and variation of output signal from the distance detection unit 76A.

As shown in FIG. 4A, the distance detection unit 70A comprises the rotation disc 71A and a detector unit 72. The rotation plate 71A is fixed on the massaging shaft 63 between the supporting plate 51a and the first arm 64a so that the rotation center “O” of the rotation disc 71A coincides with the center axis of the massaging shaft 63 (the massaging shaft 63 is not illustrated in FIGS. 4A and 4B). The rotation disc 71A has a first aperture (sensing area) 711A and a second aperture (sensing area) 712A which are independently formed. As shown in FIG. 4B, the first and second apertures 711A and 712A are respectively arc shaped openings having a width W in radial direction of the rotation disc 71A formed along a circle having a radius of “r” from the center “O”. The second aperture 712A is formed to be distant a predetermined angular interval “α” around the center “O” from the first aperture 711A.

The detector unit 72 comprises a transmission photo-interrupter constituted by a light emitting device 721 and a light receiving device 722 which are mounted on a circuit board 723. The light emitting device 721 is, for example, an LED which emits a light of predetermined wavelength. The light receiving device 722 is constituted by, for example, a series connection of a photodiode and a resistor for generating a photoelectric current corresponding to a quantity of received light by photoelectric conversion of the photodiode, converting the photoelectric current to voltage by the resistor and outputting a voltage signal as an output (a detection signal) therefrom. Alternatively, the light receiving device 722 may be constituted by, for example, a series connection of a phototransistor and a resistor.

Hereupon, the detection signals outputted from the distance detection unit 70A can be established that the variations of the output signal of the detector unit 72 from low level “0” to high level “1” and high level “1” to low level “0” are assumed as one detection signal.

The circuit board 723 on which the light emitting device 721 and the light receiving device 722 are mounted is fixed on a supporting plate 73 having a substantially L-shaped section which is further fixed on the supporting plate 51a (referring to FIG. 3A) in a manner so that the rotation disc 71A is disposed between the light emitting device 721 and the light receiving device 722 and the first and second apertures 711A and 712A can face the light emitting device 721 and the light receiving device 722.

By such a configuration, when the edges of the first and second apertures 711A and 712A pass a reference position facing the light emitting device 721 and the light receiving device 722, the output from the light receiving device 722 varies.

Referring to FIG. 4B and FIG. 5, when the massaging motor 61 is driven so that the massaging shaft 63 is rotated, the rotation disc 71A of the distance detection unit 70A is rotated in, for example, counterclockwise direction shown by arrow CW in FIG. 4B. When a front edge PA1 of the first aperture 711A reaches to the reference position facing the light emitting device 721 at a time TPA1 shown in FIG. 5, light emitted from the light emitting device 721 reaches to the light receiving device 722 through the first aperture 711A, so that the light emitting device 722 outputs a voltage corresponding to quantity of received light as a detection signal. In other words, the output signal from the detector unit 72 varies from low level “0” to high level “1” at the time TPA1.

When the rotation disc 71A further rotates and a rear edge PA2 of the first aperture 711A reaches to the reference position facing the light emitting device 721 at a time TPA2, light emitted from the light emitting device 721 is shielded by the rotation disc 71A and cannot reach to the light receiving device 722, so that the output signal from the detector unit 72 varies from high level “1” to low level “0” at the time TPA2.

When the rotation disc 71A still further rotates and a front edge PA3 of the second aperture 712A reaches to the reference position facing the light emitting device 721 at a time TPA3, light emitted from the light emitting device 721 reaches to the light receiving device 722 through the second aperture 712A, so that the light emitting device 722 outputs a voltage corresponding to quantity of received light as a detection signal. In other words, the output signal from the detector unit 72 varies from low level “0” to high level “1” at the time TPA3.

When the rotation disc 71A still further rotates and a rear edge PA4 of the second aperture 712A reaches to the reference position facing the light emitting device 721 at a time TPA4, light emitted from the light emitting device 721 is shielded by the rotation disc 71A and cannot reach to the light receiving device 722, so that the output signal from the detector unit 72 varies from high level “1” to low level “0” at the time TPA4.

When the rotation disc 71A still further rotates and the front edge PA1 of the first aperture 711A reaches to the reference position facing the light emitting device 721, the above-mentioned motions are repeated.

In this way, it is possible to homologize the rotation angle or position of the rotation disc 71A to the variation of the output signal from the detector unit 72. It, however, is impossible to distinguish the detection of the first aperture 711A from the detection of the second aperture 712A by only the variation of the level of the output signal from the detector unit 72. In other words, it is impossible to detect the rotation angle or position of the rotation disc 71A by the variation of the level of the output signal from the detector unit 72. Therefore, a length of the first aperture 711A in circumferential direction of the rotation disc 71A is different from that of the second aperture 712A.

As shown in FIG. 5, a term from TPA1 to TPA2 where the high level of the output signal from the detector unit 72 continues due to the first aperture 711A passes the reference position facing the light emitting device 721 is longer than a term from TPA3 to TPA4 where the high level of the output signal from the detector unit 72 continues due to the second aperture 712A passes the reference position facing the light emitting device 721. Therefore, it is possible to distinguish the detection of the first aperture 711A from the detection of the second aperture 712A by comparing the term where the high level of the output signal from the detector unit 72 continues. Furthermore, it is possible to detect the rotation angle or position of the rotation disc 71A or the massaging shaft 63 roughly by monitoring the variation of the level of the output signal from the detector unit 72.

The distance control unit 76A comprises functions of a timer 761A, a rotation angle judger 762A and a massaging motor controller 763A. The timer 761A counts a term that the high level of the output signal from the detector unit 72 continues, in other words, a term that the distance detection unit 70A continues to output the detection signals. The rotation angle judger 762A judges the rotation angle or position of the rotation disc 71A, for example, angles or positions corresponding to the edges PA1 to PA4 of the first and second apertures 711A and 712A on the basis of the variation of the output signal from the detector unit 72 of the distance detection unit 70A. The massaging motor controller 763A controls the driving of the motor on the basis of the rotation angle information signal from the rotation angle judger 762A so as to adjust the distance between the medical treating members 66a and 66b.

The distances between the medical treating members 66a and 66b are homologized to the rotation angles or positions of the rotation disc 71A corresponding to the edges PA1 to PA4 of the first and second apertures 711A and 712A. For example, the rear edge PA2 of the first aperture 711A is homologized to a state that the distance between the medical treating members 66a and 66b becomes the largest. Similarly, the front edge PA3 of the second aperture 712A is homologized to a state that the distance between the medical treating members 66a and 66b becomes middle. And, the rear edge PA4 of the second aperture 712A is homologized to a state that the distance between the medical treating members 66a and 66b becomes the smallest.

Since the distance between the medical treating members 66a and 66b varies from the largest to the smallest by caracoling the massaging shaft 63, the rear edge PA2 of the first aperture 711A and the rear edge PA4 of the second aperture 712A are located on the same line passing through the center O, as shown in FIG. 4B. The front edge PA3 of the second aperture 712A is optionally decided to take the distance between the medical treating members 66a and 66b a middle value between the largest value and the smallest value thereof. The front edge PA1 of the first aperture 711A is optionally decided so that the length l_{A1} of the first aperture 711A becomes longer than the length l_{A2} of the second aperture 712A. In the example shown in FIG. 4B, the length l_{A1} of the first aperture 711A is set to be a quarter of a circle having a radius “r”.

By such a configuration, when the distance detection unit 70A detects the rear edge PA2 of the first aperture 711A, in other words, when the level of the output signal from the detector unit 72 of the distance detection unit 70A varies from high level “1” to low level “0”after continuation of a predetermined term, the rotation angle judger 762A can judges that the massaging shaft 63 is rotated to a position where the distance between the medical treating members 66a and 66b becomes the largest. By detecting the edges PA1 to PA4 of the first and second apertures 711A and 712A by the distance detection unit 70A and the rotation angle judger 762A, it is possible to detect the distance between the medical treating members 66a and 66b.

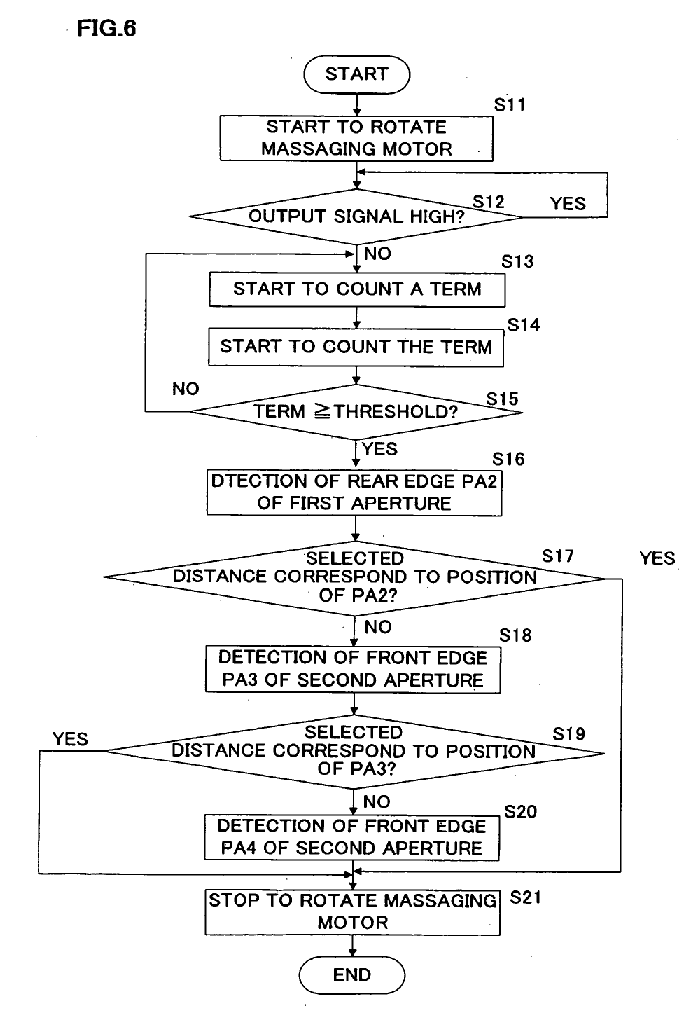

Subsequently a motion of the distance control unit 76A in the first embodiment is described with reference to FIG. 6.

When the distance control unit 76A receives a distance selection signal for instructing a distance between the medical treating members 66a and 66b, it drives the massaging motor 61 for rotating the massaging shaft 63 in counterclockwise direction (S11). Following to the rotation of the massaging shaft 63, the massaging inner wheels 67a and 67b and the rotation disc 71A of the distance detection unit 70A are also rotated in counterclockwise direction as shown by arrow CW in FIG. 4B.

The distance detection unit 76A judges whether the output signal from the distance detection unit 70A is high level, that is, the voltage of the output signal is higher than a predetermined threshold, or not, just after the starting of the driving of the massaging motor 61 (S12). When the distance detection unit 70A is high level, the distance detection unit 76A waits till the output signal from the distance detection unit 70A becomes low level. Alternatively, when the distance detection unit 70A is low level, the distance detection unit 76A proceeds to following step S13.

The rotation disc 71A may be stopped so that the first or second aperture 711A or 712A faces to the detector unit 72 corresponding to the medical treatment which is performed at the last minute. If the following steps are executed under a condition that the output signal from the distance detection unit 70A is high level, the rotation angle judger 762A of the distance detection unit 76A might misjudge the detection of the reference position. Especially, in case that the length l_{A2} of the second aperture 712A is set to be longer than the length l_{A1} of the first aperture 711A differently from this embodiment, the misjudgment frequently occurs.

When the front edge PA1 of the first aperture 711A or the front edge PA3 of the second aperture 712A reaches to the reference position facing the detector unit 72 by the rotation of the rotation disc 71A, light emitted from the light emitting device 721 reaches to the light receiving device 722 through the first aperture 711A, so that the light emitting device 722 outputs a voltage corresponding to quantity of received light as a detection signal of the distance detection unit 70A.

When the detection signal from the distance detection unit 70A is received, in other words, when the output signal from the detector unit 72 of the distance detection unit 70A varies from low level “0” to high level “1”, the timer 761A of the distance control unit 76A starts to count a term that the high level of the output signal continues (S13). For example when the timer 761A is constituted by a counter, the timer 761A starts to count up a count number from “0” by passing a predetermined term when it senses the variation of the output signal of the distance detection unit 70A from low level to high level.

When the rotation disc 71A further rotates and the rear edge PA2 of the first aperture 711A or the rear edge PA4 of the second aperture 712A reaches to the reference position facing the detector unit 72, light emitted from the light emitting device 721 is shielded by the rotation disc 71A and cannot reach to the light receiving device 722, so that the output signal from the distance detection unit 70A varies from high level to low level.

When the output signal from the distance detection unit 70A varies from high level to low level, the timer 761A stops to count the term, and outputs the counted term to the rotation angle judger 762A (S14). When the timer 761A is constituted by a counter, the timer 761A stops the counting of time when the output signal from the distance detection unit 70A varies from high level to low level, and outputs a counted value to the rotation angle judger 762A

The rotation angle judger 762A judges whether the distance detection unit 70A detects the edges of the first aperture 711A or not by comparing the counted term from the timer 761A with a predetermined threshold (S15). Since the threshold is set to be a term necessary for rotating the rotation disc 71A by a predetermined angle with a predetermined rotation speed corresponding to the length l_{A1} of the first aperture 711A, when the counted term is equal to or larger than the threshold, it is possible to judge that the edges of the first aperture 711A are detected. When the timer 761A is constituted by the counter, the rotation angle judger 762A compares the counted number with a reference number as the threshold.

Alternatively, when the counted term is smaller than the threshold, the rotation angle judger 762A judges that the edges of the first aperture 711A are not detected, and the operation is returned to the step S13 so as to detect the edges of the first aperture 711A.

When the rotation angle judger 762A judges that the edges of the first aperture 711A are detected, it further judges that the rear edge PA2 of the first aperture 711A is positioned at the reference position facing the detector unit 62, that is, the massaging shaft 63 is rotated to the reference position when the output signal from the distance detection unit 70A varies from high level to low level, and outputs a rotation angle information signal corresponding to the rear edge PA2 of the first aperture 711A to the massaging motor controller 763A (S16).

When the massaging motor controller 763A receives the rotation angle information signal corresponding to the rear edge PA2 of the first aperture 711A, it judges whether the distance between the medical treating members 66a and 66b instructed by the distance selection signal in the step S11 coincides with the distance corresponding to the rotation angle of the rotation angle information signal corresponding to the rear edge PA2 of the first aperture 711A, or not (S17).

When the distance between the medical treating members 66a and 66b selected by the distance selection signal in the step S11 coincides with the distance corresponding to the rotation angle of the rotation angle information signal corresponding to the rear edge PA2 of the first aperture 711A, the massaging motor controller 763A stops to drive the massaging motor 61 (S21). Thereby, the distance between the medical treating members 66a and 66b is set to be the largest, which is selected by the distance selection signal.

Alternatively, when the distance between the medical treating members 66a and 66b selected by the distance selection signal in the step S11 does not coincide with the distance corresponding to the rotation angle of the rotation angle information signal corresponding to the rear edge PA2 of the first aperture 711A, the massaging motor controller 763A waits till the output signal from the distance detector unit 70A varies from low level to high level.

When the rotation disc 71A still further rotates and the front edge PA3 of the second aperture 712A reaches to the reference position facing the detector unit 72, light emitted from the light emitting device 721 reaches to the light receiving device 722 through the second aperture 712A, so that the light emitting device 722 outputs a voltage corresponding to quantity of received light as a detection signal. In other words, the output signal from the distance detector unit 70A varies from low level to high level.

When the output signal from the distance detector unit 70A varies from low level to high level, the rotation angle judger 762A judges that the front edge PA3 of the second aperture 712A is positioned at the reference position facing the detector unit 72, and outputs a rotation angle information signal corresponding to the front edge PA3 of the second aperture 712A to the massaging motor controller 763A (S18).

When the massaging motor controller 763A receives the rotation angle information signal corresponding to the front edge PA3 of the second aperture 712A, it judges whether the distance between the medical treating members 66a and 66b selected by the distance selection signal in the step S11 coincides with the distance corresponding to the rotation angle of the rotation angle information signal corresponding to the front edge PA3 of the second aperture 712A, or not (S19).

When the distance between the medical treating members 66a and 66b selected by the distance selection signal in the step S11 coincides with the distance corresponding to the rotation angle of the rotation angle information signal corresponding to the front edge PA3 of the second aperture 712A, the massaging motor controller 763A stops to drive the massaging motor 61 (S21). Thereby, the distance between the medical treating members 66a and 66b is set to be middle, which is selected by the distance selection signal.

Alternatively, when the distance between the medical treating members 66a and 66b selected by the distance selection signal in the step S11 does not coincide with the distance corresponding to the rotation angle of the rotation angle information signal corresponding to the front edge PA3 of the second aperture 712A, the massaging motor controller 763A waits till the output signal from the distance detector unit 70A varies from high level to low level.

When the rotation disc 71A still further rotates and the rear edge PA4 of the second aperture 712A reaches to the reference position facing the detector unit 72, light emitted from the light emitting device 721 is shielded by the rotation disc 71A and cannot reach to the light receiving device 722, so that the output signal from the distance detector unit 70A varies from high level to low level.

When the output signal from the distance detector unit 70A varies from high level to low level, the rotation angle judger 762A judges that the rear edge PA4 of the second aperture 712A is positioned at the reference position facing the detector unit 72, and outputs a rotation angle information signal corresponding to the rear edge PA4 of the second aperture 712A to the massaging motor controller 763A (S20).

When the massaging motor controller 763A receives the rotation angle information signal corresponding to the rear edge PA4 of the second aperture 712A, the massaging motor controller 763A stops to drive the massaging motor 61 (S21). Thereby, the distance between the medical treating members 66a and 66b is set to be the smallest, which is selected by the distance selection signal.

According to the massager 1 in the first embodiment, the distance between two pairs of the medical treating members 66a and 66b which are respectively disposed right and left side portions in widthwise direction of the massager 1 can be varied in three stages. The first and second apertures 711A and 712A are respectively formed on the same circle having the radius “r” from the center “O” on the rotation disc 71A, so that the diameter of the rotation disc 71A can be made smaller in comparison with that in the conventional massager. Furthermore, the detector unit 72 of the distance detection unit 70A is configured by only one set of the light emitting device 721 such as an LED and a light receiving device 722 such as a photodiode or a phototransistor, so that the configuration of the detector unit 72 can be made simple and the cost thereof can be reduced. Still furthermore, the position of the detector unit 72 with respect to the first and second apertures 711A and 712A of the rotation disc 71A can easily be adjusted.

In addition, in the above-mentioned description, the length of the second aperture 712A in the circumferential direction of the rotation disc 71A is made shorter than that of the first aperture 711A, and three selectable distances between the medical treating members 66a and 66b to be selected are respectively homologized to the rear edge PA2 of the first aperture 711A, the front edge PA3 of the second aperture 712A and the rear edge PA4 of the second aperture 712A. It, however, is possible to provide a plurality of second apertures having a shorter length in the circumferential direction of the rotation disc. By providing a plurality of the second apertures on the rotation disc, it is possible to adjust the distance between the medical treating members 66a and 66b more than three stages.

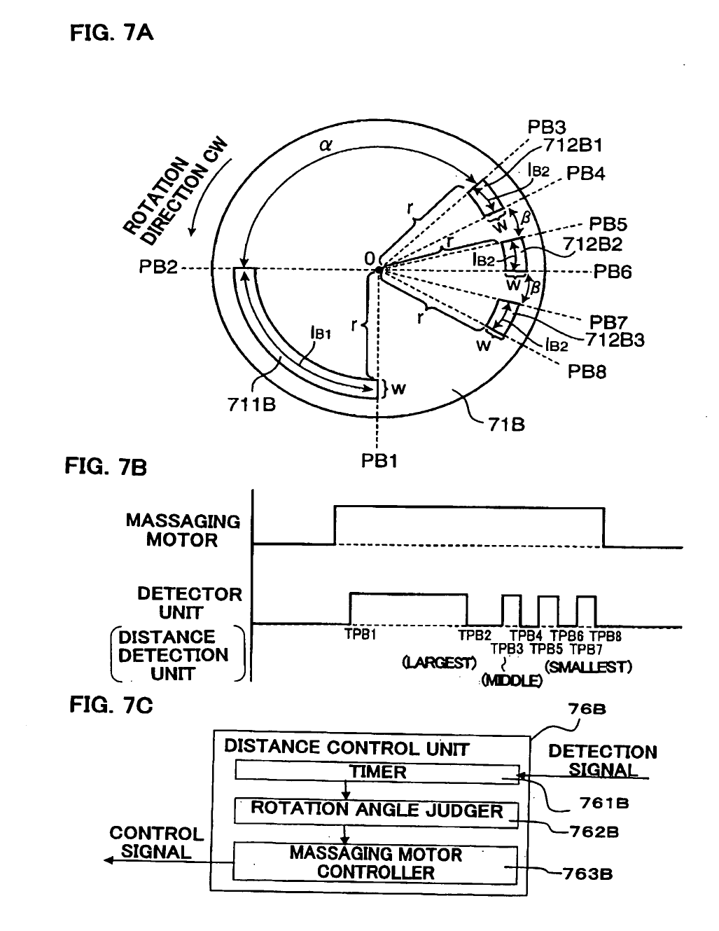

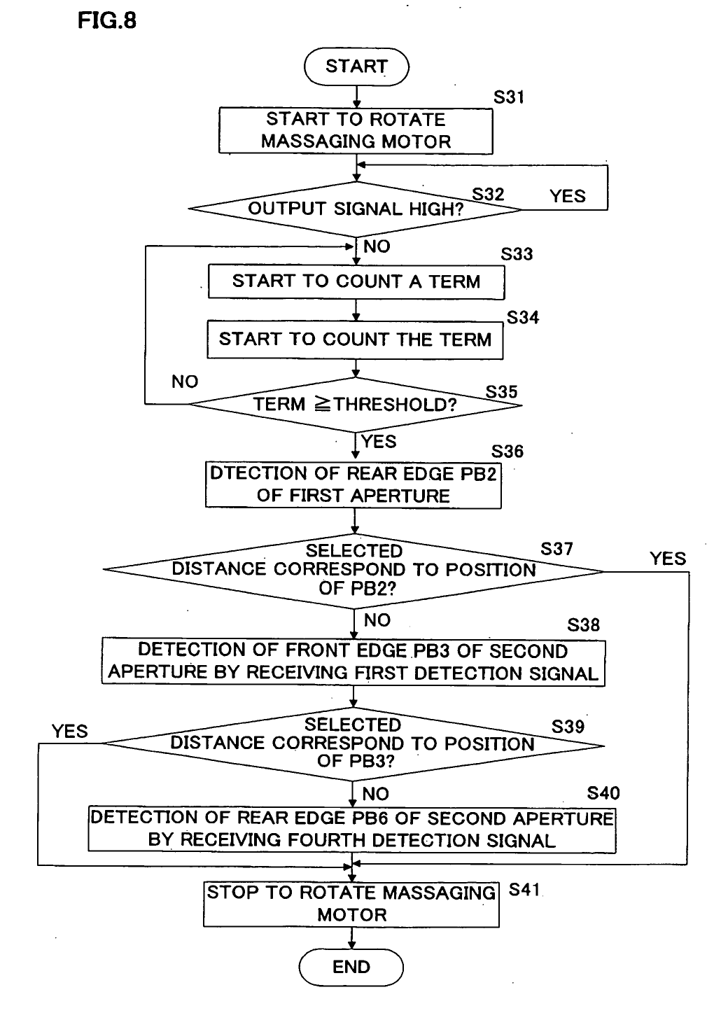

Subsequently, a modified example of the massager 1 in the first embodiment is described with reference to FIGS. 7A to 7C and FIG. 8. FIG. 7A shows a configuration of a rotation disc 71B having three second apertures 712B1, 712B2 and 712B3, FIG. 7B shows on and off of the massaging motor and variation of output signal from a modified distance detection unit (distance detector) 70B, and FIG. 7C shows a block configuration of the distance controller (distance controller) 76B. The configuration of the distance detection unit 70B except the rotation disc 71B is substantially the same as that of the distance detection unit 70A, so that the description of common elements is omitted.

As shown in FIG. 7A, the rotation disc 70B has one first aperture 711B and three second apertures 712B1, 712B2 and 712B3, which are independently formed on the same circle having a diameter “r” from the center “O” on the rotation disc 70B. The first aperture 711B has a length l_{B1} in the circumferential direction and a width “W” in the radial direction of the rotation disc 70B. Each of the second apertures 712B1, 712B2 and 712B3 has a length l_{B2} in the circumferential direction and a width “W” in the radial direction. The second aperture 712B1 is formed with a predetermined angular interval “α” around the center “O” from the first aperture 711B. Three second apertures 712B1, 712B2 and 712B3 are formed with a predetermined constant angular interval “β”. It, however, is possible to provide these three second apertures 712B1, 712B2 and 712B3 with unequal angular intervals.

Subsequently, a relation between the rotation of the rotation disc 71B and variation of the output signal from the detector unit 72, in other words, the detection signal of the distance detection unit 70B is described.

When the massaging motor 61 is driven so that the massaging shaft 63 is rotated, the rotation disc 71B of the distance detection unit 70B is rotated in, for example, counterclockwise direction shown by arrow CW in FIG. 7A. When a front edge PB1 of the first aperture 711B reaches to the reference position facing the light emitting device 721 at a time TPB1 shown in FIG. 7B, light emitted from the light emitting device 721 reaches to the light receiving device 722 through the first aperture 711B, so that the light emitting device 722 outputs a voltage corresponding to quantity of received light as a detection signal. In other words, the output signal from the detector unit 72 varies from low level “0” to high level “1” at the time TPB1.

When the rotation disc 71B further rotates and a rear edge PB2 of the first aperture 711B reaches to the reference position facing the light emitting device 721 at a time TPB2, light emitted from the light emitting device 721 is shielded by the rotation disc 711B and cannot reach to the light receiving device 722, so that the output signal from the detector unit 72 varies from high level “1” to low level “0” at the time TPB2.

When the rotation disc 71B still further rotates and a front edge PB3 of the second aperture 712B1 reaches to the reference position facing the light emitting device 721 at a time TPB3, light emitted from the light emitting device 721 reaches to the light receiving device 722 through the second aperture 712B1, so that the light emitting device 722 outputs a voltage corresponding to quantity of received light as a detection signal. In other words, the output signal from the detector unit 72 varies from low level “0” to high level “1” at the time TPB3.

When the rotation disc 71B still further rotates and a rear edge PB4 of the second aperture 712B1 reaches to the reference position facing the light emitting device 721 at a time TPB4, light emitted from the light emitting device 721 is shielded by the rotation disc 71B and cannot reach to the light receiving device 722, so that the output signal from the detector unit 72 varies from high level “1” to low level “0” at the time TPB4.

When the rotation disc 71B still further rotates, a front edges PB5 and a rear edge PB6 of the second aperture 712B2, and a front edge PB7 and a rear edge PB8 of the second apertures 712B3 serially reach to the reference position facing the light emitting device 721, so that the output signal from the detector unit 72 repeats the variation between high level “1” and low level “0”. When the rotation disc 71B still further rotates and the front edge PB1 of the first aperture 711B reaches to the reference position facing the light emitting device 721, the above-mentioned motions are repeated.

In this way, it is possible to homologize the rotation angle or position of the rotation disc 71B to the variation of the output signal from the detector unit 72. It, however, is impossible to detect the rotation angle or position of the rotation disc 71B by the variation of the level of the output signal from the detector unit 72. Therefore, the length l_{B1} of the first aperture 711B in the circumferential direction of the rotation disc 71B is different from the length l_{B2} of the second apertures 712B1, 712B2 and 712B3.

As shown in FIG. 7B, a term from TPB1 to TPB2 where the high level of the output signal from the detector unit 72 continues due to the first aperture 711B passes the reference position facing the light emitting device 721 is longer than a term from TPB3 to TPb4 where the high level of the output signal from the detector unit 72 continues due to the second aperture 712B1 passes the reference position facing the light emitting device 721. Therefore, it is possible to distinguish the detection of the first aperture 711B from the detection of the second aperture 712B1 by comparing the term where the high level of the output signal from the detector unit 72 continues. Furthermore, it is possible to detect the rotation angle or position of the rotation disc 71B or the massaging shaft 63 roughly by monitoring the variation of the level of the output signal from the detector unit 72.

In this modified example, the lengths l_{B2} of the second apertures 712B1, 712B2 and 712B3 are set to be the same, and the length l_{B1} of the first aperture 711B is longer than the lengths l_{B2} of the second aperture 712B1, 712B2 and 712B3. It, however, is possible to set the lengths of the second apertures 712B1, 712B2 and 712B3 different lengths each other, if they are shorter than the length l_{B1} of the first aperture 711B.

The distance control unit 76B comprises functions of a timer 761B, a rotation angle judger 762B and a massaging motor controller 763B, similar to the above-mentioned distance control unit 76A. The timer 761B counts a term that the high level of the output signal from the detector unit 72 continues, in other words, a term that the distance detection unit 70B continues to output the detection signals. The rotation angle judger 762B judges the rotation angle or position of the rotation disc 71B, for example, angles or positions corresponding to the edges PB1 to PB8 of the first and second apertures 711B, 712B1, 712B2 and 712B3 on the basis of the variation of the output signal from the detector unit 72 of the distance detection unit 70B. The massaging motor controller 763B controls the driving of the motor on the basis of the rotation angle information signal of the rotation angle judger 762B so as to adjust the distance between the medical treating members 66a and 66b.

The distances between the medical treating members 66a and 66b are homologized to the rotation angles or positions of the rotation disc 71B corresponding to the edges PB1 to PB8 of the first and second apertures 711B, 712B1, 712B2 and 712B3. For example, the rear edge PB2 of the first aperture 711B is homologized to a state that the distance between the medical treating members 66a and 66b becomes the largest. And optional two edges among the edges PB3 to PB8 are respectively homologized to a state that the distance between the medical treating members 66a and 66b becomes middle and a state that the distance between the medical treating members 66a and 66b becomes the smallest. Specifically, the front edge PB3 of the second aperture 712B1 is homologized to a state that the distance between the medical treating members 66a and 66b becomes middle. And, the rear edge PB6 of the second aperture 712B2 is homologized to a state that the distance between the medical treating members 66a and 66b becomes the smallest.

Since the distance between the medical treating members 66a and 66b varies from the largest to the smallest by caracoling the massaging shaft 63, the rear edge PB2 of the first aperture 711B and the rear edge PB6 of the second aperture 712B2 are located on the same line passing through the center O, as shown in FIG. 7A. The front edge PB3 of the second aperture 712B1 is optionally decided to take the distance between the medical treating members 66a and 66b a middle value between the largest value and the smallest value thereof. The front edge PB1 of the first aperture 711B is optionally decided so that the length l_{B1} of the first aperture 711B becomes longer than the length l_{A2} of the second aperture 712B1 between the rear edge PB2 of the first aperture 711b and the rear edge PB8 of the second aperture 712B3. In the example shown in FIG. 7A, the length l_{A1} of the first aperture 711A is set to be a quarter of a circle having a radius “r”.

By such a configuration, after detecting the rear edge PB2 of the first aperture 711B by detecting the variation of the level of the output signal from the detector unit 72 from high level “1” to low level “0” after continuation of a predetermined term, the rotation angle judger 762B can judge the rotation angle or position of the rotation disc 70B by a number of variation of the level of the output signal from the detector unit 72 between high level “1” and low level “0”. Specifically, when the level of the output signal from the detector unit 72 is varied first from low level “0” to high level “1”, it is possible to judge that the front edge PB3 of the second aperture 712B1 is positioned at the reference position facing the detector unit 72. Similarly, when the level of the output signal from the detector unit 72 is varied four times between high level “1” and low level “0”, it is possible to judge that the rear edge PB6 of the second aperture 712B2 is positioned at the reference position facing the detector unit 72.

Subsequently a motion of the distance control unit 76B in the modified example of first embodiment is described with reference to FIG. 8. In the flowchart shown in FIG. 8, steps from receiving the distance selection signal (S31) to the detection of the rear edge of the first aperture 711B (S36) are substantially the same as the steps S11 to S16 in the flowchart shown in FIG. 6, so that descriptions of them are omitted.

In step S37, when the massaging motor controller 763B receives the rotation angle information signal corresponding to the rear edge PB2 of the first aperture 711B, it judges whether the distance between the medical treating members 66a and 66b selected by the distance selection signal in the step S31 coincides with the distance corresponding to the rotation angle of the rotation angle information signal corresponding to the rear edge PB2 of the first aperture 711B, or not.

When the distance between the medical treating members 66a and 66b selected by the distance selection signal in the step S31 coincides with the distance corresponding to the, rotation angle of the rotation angle information signal corresponding to the rear edge PB2 of the first aperture 711B, the massaging motor controller 763B stops to drive the massaging motor 61 (S41). Thereby, the distance between the medical treating members 66a and 66b is set to be the largest, which is selected by the distance selection signal.

Alternatively, when the distance between the medical treating members 66a and 66b selected by the distance selection signal in the step S31 does not coincide with the distance corresponding to the rotation angle of the rotation angle information signal corresponding to the rear edge PB2 of the first aperture 711B, the massaging motor controller 763B waits till the output signal from the distance detector unit 70A varies from low level to high level, first.

When the rotation disc 71B still further rotates and the front edge PB3 of the second aperture 712B1 reaches to the reference position facing the detector unit 72, light emitted from the light emitting device 721 reaches to the light receiving device 722 through the second aperture 712B1, so that the light emitting device 722 outputs a voltage corresponding to quantity of received light as a detection signal. In other words, the output signal from the distance detector unit 70B varies from low level to high level, first.

When the output signal from the distance detector unit 70B varies from low level to high level, the rotation angle judger 762B counts up a number of times of the variation of the output signal from the detector unit 72 by one. Since the rotation angle judger 762B detects the first variation of the level of the output signal from the detector unit 72 after detecting the rear edge PB2 of the first aperture 711A, it judges that the front edge PB3 of the second aperture 712B1 is positioned at the reference position facing the detector unit 72, and outputs a rotation angle information signal corresponding to the front edge PB3 of the second aperture 712B1 to the massaging motor controller 763B (S38).

When the massaging motor controller 763B receives the rotation angle information signal corresponding to the front edge PB3 of the second aperture 712B1, it judges whether the distance between the medical treating members 66a and 66b selected by the distance selection signal in the step S31 coincides with the distance corresponding to the rotation angle of the rotation angle information signal corresponding to the front edge PB3 of the second aperture 712B1, or not (S39).

When the distance between the medical treating members 66a and 66b selected by the distance selection signal in the step S31 coincides with the distance corresponding to the rotation angle of the rotation angle information signal corresponding to the front edge PB3 of the second aperture 712B1, the massaging motor controller 763B stops to drive the massaging motor 61 (S41). Thereby, the distance between the medical treating members 66a and 66b is set to be middle, which is selected by the distance selection signal.

Alternatively, when the distance between the medical treating members 66a and 66b selected by the distance selection signal in the step S31 does not coincide with the distance corresponding to the rotation angle of the rotation angle information signal corresponding to the front edge PB3 of the second aperture 712B1, the massaging motor controller 763B waits till the output signal from the distance detector unit 70A varies predetermined times (for example, thrice) between high level and low level.

When the rotation disc 71B still further rotates and the rear edge PB4 of the second aperture 712B1 reaches to the reference position facing the detector unit 72, light emitted from the light emitting device 721 is shielded by the rotation disc 71B and cannot reach to the light receiving device 722, so that the output signal from the distance detector unit 70B varies from high level to low level. The rotation angle judger 762B counts up a number of times of the variation of the output signal from the detector unit 72 by one. Consequently, the counted number of times of the variation of the output signal from the detector unit 72 becomes “2”. Following to the rotation of the rotation disc 71A, the output signal from the detector unit 72 repeats the variation between high level and low level, and the counted number of times of the variation of the output signal increases one by one.

When the counted number of times of the variation of the output signal reaches to “4”, the rotation angle judger 762B judges that the rear edge PB6 of the second aperture 712B2 is positioned at the reference position facing the detector unit 72, and outputs a rotation angle information signal corresponding to the rear edge PB6 of the second aperture 712B2 to the massaging motor controller 763B (S40).

When the massaging motor controller 763B receives the rotation angle information signal corresponding to the rear edge PB6 of the second aperture 712B2, the massaging motor controller 763B stops to drive the massaging motor 61 (S41). Thereby, the distance between the medical treating members 66a and 66b is set to be the smallest, which is selected by the distance selection signal.

According to the massager 1 in the modified example of the first embodiment, the distance between two pairs of the medical treating members 66a and 66b which are respectively disposed right and left side portions in widthwise direction of the massager 1 can be varied in three stages. The first and second apertures 711B, 712B1, 712B2 and 712B3 are respectively formed on the same circle having the radius “r” from the center “O” on the rotation disc 71B, so that the diameter of the rotation disc 71B can be made smaller in comparison with that in the conventional massager. Furthermore, the detector unit 72 of the distance detection unit 70B is configured by only one set of the light emitting device 721 such as an LED and a light receiving device 722 such as a photodiode or a phototransistor, so that the configuration of the detector unit 72 can be made simple and the cost thereof can be reduced. Still furthermore, the position of the detector unit 72 with respect to the first and second apertures 711B, 712B1, 712B2 and 712B3 of the rotation disc 71B can easily be adjusted. Still furthermore, the rotation disc 71B in the modified embodiment has a plurality of, for example, three second apertures, so that it is easy to adjust the distance between the medical treating members 66a and 66b at stages more than four.

### Second Embodiment

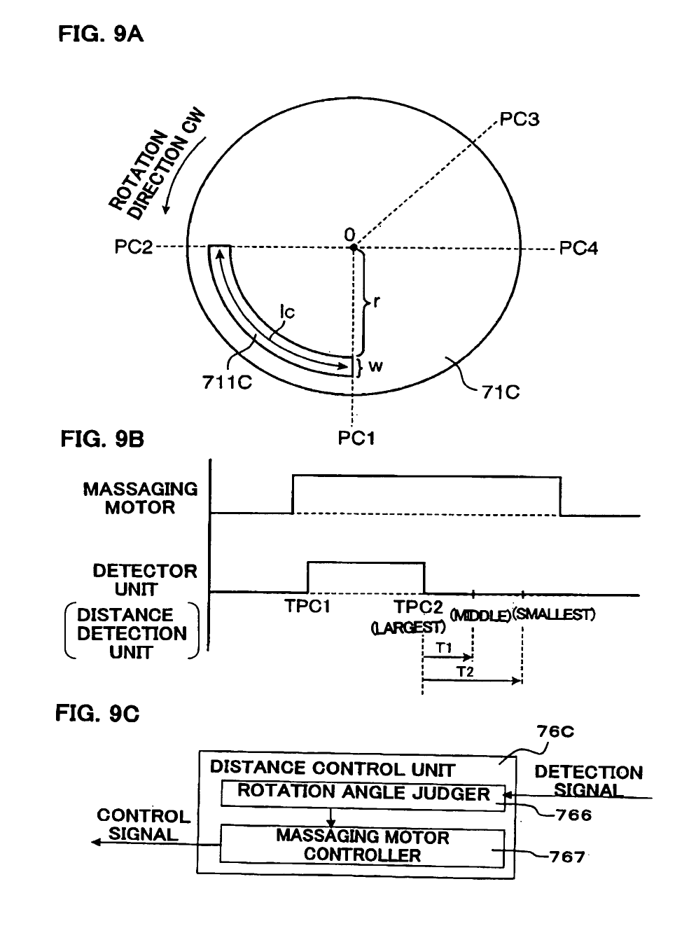

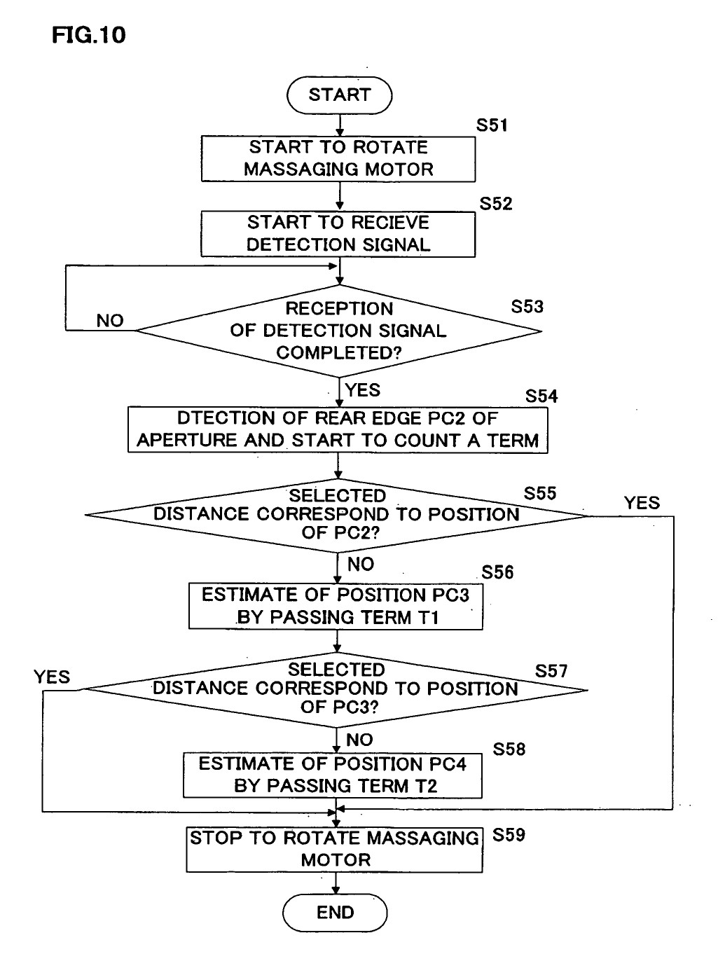

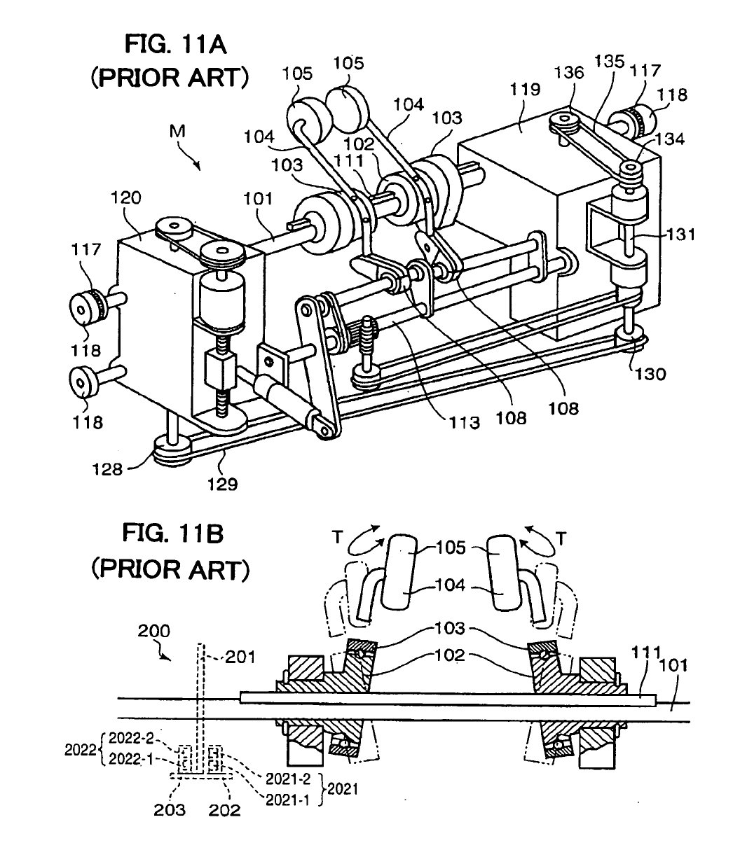

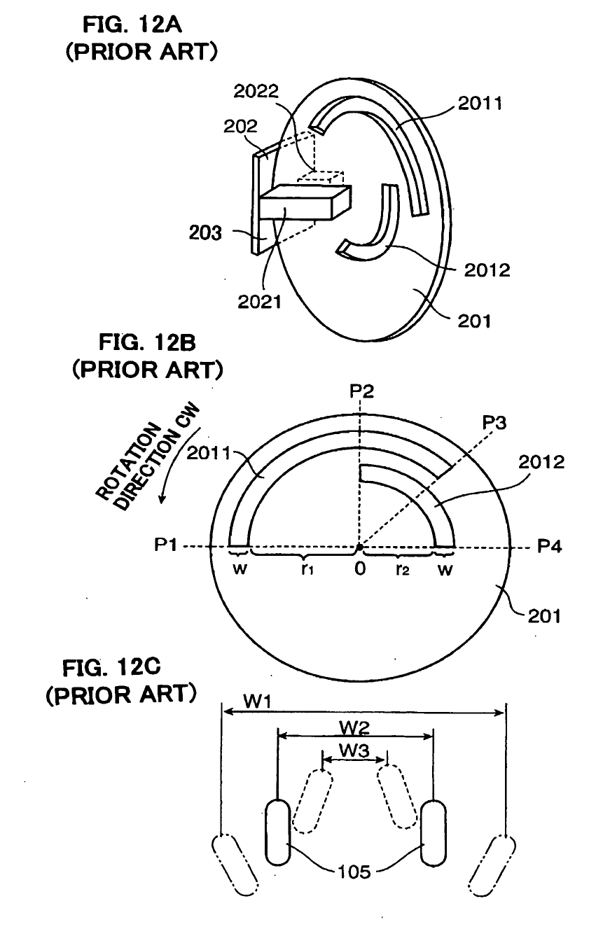

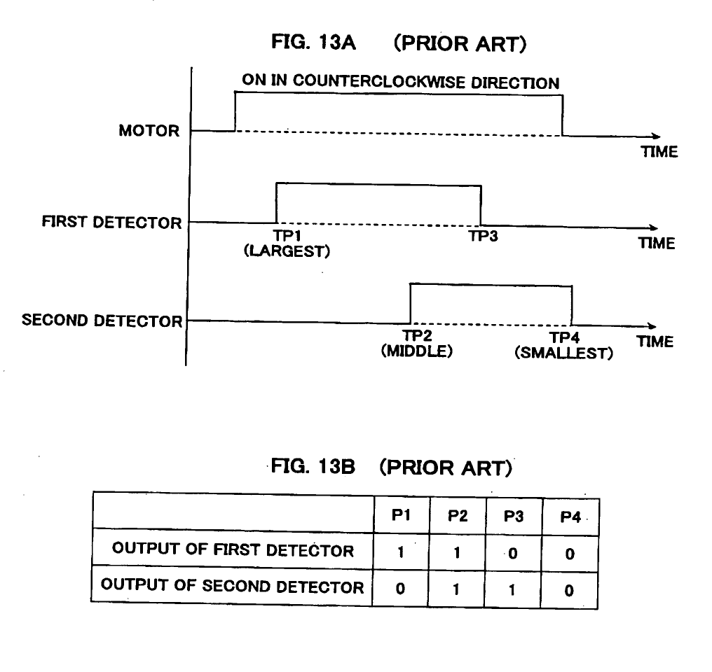

A massager in accordance with a second embodiment of the present invention is described with reference to FIGS. 9A to 9C, and FIG. 10. In the second embodiment, the rotation angle or position of the rotation disc of the distance detection unit, that is, the distance between the medical treating members is estimated on the basis of a time after detecting an edge of an aperture formed on the rotation disc.

The basic configuration of the massager in the second embodiment is substantially the same as that in the above-mentioned first embodiment. Thus, different points of the massager in the second embodiment are described.

FIG. 9A shows a configuration of a rotation disc 71C of a distance detection unit (distance detector) 70C, FIG. 9B shows on and off of the massaging motor 61 and variation of the output signal from the detector unit 72 of the distance detection unit 70C, and FIG. 9C shows a block configuration of a distance control unit (distance controller) 76C.

As shown in FIG. 9A, the rotation disc 71C has only one arc shaped aperture 711C formed along a circle with a radius “r” from the center “O” and having a length l_{c} in the circumferential direction and a width “W” in the radial direction thereof. Since the rotation disc 71C has only one aperture 711C, it can detect only two points of rotation angle or position of the rotation disc 71C. In the second embodiment, the rotation angle or position of the rotation disc 71C is estimated on the basis of the term T after detecting a rear edge PC2 of the aperture 711C. The length l_{C} of the aperture 711C is optionally set to be sufficient to distinguish a front edge PC1 from the rear edge PC2.

The distance control unit 76C comprises functions a rotation angle judger 766 and a massaging motor controller 767. The rotation angle judger 766 detects that the rear end PC2 of the aperture 711C passes a reference position facing the detector unit 72 of the distance detection unit 70C from the variation of the output signal from the detector unit 72 (hereinafter, abbreviated as “detection of the rear edge PC2 of the aperture 711C”), counts a term from the detection of the detection of the rear edge PC2 of the aperture 711C, estimates the rotation angle or the position of the rotation disc 71C with using the counted term and the rotation speed of the rotation disc 71C, and outputs a rotation angle information signal to the massaging motor controller 767. The massaging motor controller 767 controls the driving of the massaging motor 61 on the basis of the output of the rotation angle judger 766 so as to adjust the distance between the medical treating members 66a and 66b.

The largest and smallest distances between the medical treating members 66a and 66b are optionally homologized to the rotation angles or positions of the rotation disc 71C. For example, the rear edge PC2 of the aperture 711C is homologized to a state that the distance between the medical treating members 66a and 66b becomes the largest. Since the distance between the medical treating members 66a and 66b varies from the largest to the smallest by caracoling the massaging shaft 63, a position PC4 on the same line passing the rear edge PC2 of the aperture 711C and the center “O” is homologized to a state that the distance between the medical treating members 66a and 66b becomes the smallest. An optional position PC3 between the rear edge PC2 of the aperture 711C and the position PC4 is homologized to a state that the distance between the medical treating members 66a and 66b becomes the middle. The, terms T1 and T2 during which the rotation disc 71C rotates the angles from the rear edge PC2 of the aperture 711C to the points PC3 and PC4 are established in consideration of the rotation speed of the rotation disc 71C.

With such a configuration, it is possible to estimate that the point PC3 or PC4 on the rotation disc 71C is positioned at the reference position facing the detector unit 72 when the term T1 or T2 has passed after detection of the rear edge PC2 of the aperture 711C.

Subsequently, the motion of the distance control unit 76C in the second embodiment is described with reference to a flowchart shown in FIG. 10.

When the distance control unit 76C receives a distance selection signal for instructing a distance between the medical treating members 66a and 66b, it drives the massaging motor 61 for rotating the massaging shaft 63 in counterclockwise direction (S51). Following to the rotation of the massaging shaft 63, the massaging inner wheels 67a and 67b and the rotation disc 71C of the distance detection unit 70C are also rotated in counterclockwise direction as shown by arrow CW in FIG. 9A.

When the front edge PC1 of the aperture 711C reaches to the reference position facing the detector unit 72 following to the rotation of the rotation disc 71C, light emitted from the light emitting device 721 reaches to the light receiving device 722, so that the output(of the light receiving device 722 varies from low level “0” to high level “1”, thereby the distance control unit 76C starts to receive a detection signal from the distance detection unit 70C (S52). The distance control unit 76C continues to receive the detection signal until the rear edge PC2 of the aperture 711C reaches to the reference position facing the detector unit 72 (S53).

When the rear edge PC2 of the aperture 711C reaches to the reference position facing the detector unit 72, light emitted from the light emitting device 721 is shielded by the rotation disc 71C, so that the output of the light receiving device 722 varies from high level “1” to low level “0”. Thereby, the rotation angle judger 766 of the distance control unit 76C judges that the rear edge PC2 of the aperture 711C reaches to the reference position, starts to count a term “T” after the detection of rear edge PC2 of the aperture 711C, and outputs a rotation angle information signal corresponding to the rear edge PC2 of the aperture 711C to the massaging motor controller 767 (S54).

When the massaging motor controller 767 receives the rotation angle information signal corresponding to the rear edge PC2 of the aperture 711C, it judges whether the distance between the medical treating members 66a and 66b selected by the distance selection signal in the step S51 coincides with the distance corresponding to the rotation angle of the rotation angle information signal corresponding to the rear edge PC2 of the aperture 711C, or not (S55).

When the distance between the medical treating members 66a and 66b selected by the distance selection signal coincides with the distance corresponding to the rotation angle of the rotation angle information signal corresponding to the rear edge PC2 of the aperture 711C, the massaging motor controller 767 stops to drive the massaging motor 61 (S59). Thereby, the distance between the medical treating members 66a and 66b is set to be the largest, which is selected by the distance selection signal.

Alternatively, when the distance between the medical treating members 66a and 66b selected by the distance selection signal does not coincide with the distance corresponding to the rotation angle of the rotation angle information signal corresponding to the rear edge PC2 of the aperture 711C, the massaging motor controller 767 waits another rotation angle information signal from the rotation angle judger 766.

When the rotation disc 71A still further rotates and the counted term “T” reaches to the predetermined term T1, the rotation angle judger 766 judges that the position PC3 of the rotation disc 71C reaches to the reference position, and outputs a rotation angle information signal corresponding to the position PC3 to the massaging motor controller 767 (S56).

When the massaging motor controller 767 receives the rotation angle information signal corresponding to the position PC3 of the rotation disc 71C, it judges whether the distance between the medical treating members 66a and 66b selected by the distance selection signal coincides with the distance corresponding to the rotation angle of the rotation angle information signal corresponding to the position PC3, or not (S57).

When the distance between the medical treating members 66a and 66b selected by the distance selection signal coincides with the distance corresponding to the rotation angle of the rotation angle information signal corresponding to the position PC3, the massaging motor controller 767 stops to drive the massaging motor 61 (S59). Thereby, the distance between the medical treating members 66a and 66b is set to be the middle, which is selected by the distance selection signal.

Alternatively, when the distance between the medical treating members 66a and 66b selected by the distance selection signal does not coincide with the distance corresponding to the rotation angle of the rotation angle information signal corresponding to the position PC3, the massaging motor controller 767 waits another rotation angle information signal from the rotation angle judger 766.

When the rotation disc 71A still further rotates and the counted term “T” reaches to the predetermined term T2, the rotation angle judger 766 judges that the position PC4 of the rotation disc 71C reaches to the reference position, and outputs a rotation angle information signal corresponding to the position PC4 to the massaging motor controller 767 (S58).

When the massaging motor controller 767 receives the rotation angle information signal corresponding to the position PC4, the massaging motor controller 767 stops to drive the massaging motor 61 (S59). Thereby, the distance between the medical treating members 66a and 66b is set to be the smallest, which is selected by the distance selection signal.

According to the massager in the second embodiment, the distance between two pairs of the medical treating members 66a and 66b which are respectively disposed right and left side portions in widthwise direction of the massager 1 can be varied in three stages. Since only one aperture 711C is formed on the rotation disc 71C, so that the diameter of the rotation disc 71C can be made smaller in comparison with that in the conventional massager. Furthermore, the detector unit 72 of the distance detection unit 70C is configured by only one set of the light emitting device 721 and the light receiving device 722, so that the configuration of the detector unit 72 can be made simple and the cost thereof can be reduced. Still furthermore, the position of the detector unit 72 with respect to the aperture 711c of the rotation disc 71C can easily be adjusted.

### Other Modifications

In the above-mentioned embodiments, a time is necessary for the data processing of the adjustment of the distance between the medical treating members 66a and 66b after the distance detection unit 70A, 70B or 70C outputs the detection signal. Thus, a discrepancy between the purposed distance and the actual distance may occur in the distance of the medical treating members 66a and 66b due to the rotation of the massaging motor 61 while the data processing. Thus, it is preferable to rotate the rotation disc 71A, 71B or 71C in the same direction at any time while adjusting the distance between the medical treating members 66a and 66b. By rotating the rotation disc 71A, 71B or 71C in the same direction at any time, the above-mentioned discrepancy between the purposed distance and the actual distance due to the rotation of the massaging motor 61 can be estimated and corrected, so that the distance between the medical treating members 66a and 66b can be adjusted precisely.

Furthermore, it is preferable to rotate the rotation disc 71A, 71B or 71C in the same rotation speed at any time while adjusting the distance between the medical treating members 66a and 66b. By rotating the rotation disc 71A, 71B or 71C in the same rotation speed at any time, the above-mentioned discrepancy between the purposed distance and the actual distance due to the rotation of the massaging motor 61 can be estimated and corrected, so that the distance between the medical treating members 66a and 66b can be adjusted more precisely.

Furthermore, it is sufficient that the aperture(s) 711A, and 712A, 711B and 712B1 to 712B3, or 711C formed on the rotation discs 71A, 71B or 71C are(is) formed arc shape, so that the shape of the rotation disc 71A, 71B or 71C is not restricted to be circular.

Still furthermore, when the transmission type photo-interrupter is used for the detector unit 72 of the distance detection unit 70A, 70B or 70C, it is sufficient that the light emitted from the light emitting device 721 can be reached to the light receiving device 722. Therefore, the rotation disc 71A, 71B or 71C can be formed of a transparent material, and a surface thereof except a sensing area or sensing areas corresponding to the aperture(s) 711A, and 712A, 711B and 712B1 to 712B3, or 711C be coated by non-transparent material.

Alternatively, when a reflection type photo-interrupter is used for the detector unit 72 of the distance detection unit 70A, 70B or 70C, the rotation disc 71A, 71B or 71C can be formed of a non-transparent material, and a portion or portions corresponding to the sensing area(s) corresponding to the aperture(s) 711A, and 712A, 711B and 712B1 to 712B3, or 711C on a surface thereof is coated by a material having a reflectance higher than that of the non-transparent material.

This application is based on Japanese patent application 2004-340022 filed Nov. 25, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. A massager comprising a pair of medical treating members, a motor for generating a driving force, a converting mechanism for converting rotation of a shaft of the motor to a motion for varying a distance between the medical treating members, a distance detector for detecting the distance between the medical treating members, and a distance controller for controlling the distance between the medical treating members among at least three stages, wherein
the distance detector is comprised of a rotation disc which is rotated with a driving shaft of the converting mechanism and has at least two arc shaped sensing areas formed along a same circle having a predetermined radius from a rotation center of the disc, and an optical detector provided for facing the rotation disc for detecting passage of edges of the sensing areas in the circumferential direction of the rotation of the rotation disc and for outputting detection signals corresponding to detection of the edges of the sensing areas;
the sensing areas are formed so that at least one sensing area has a length in the circumferential direction different from that of another sensing area so as to be distinguished from others, and at least three edges of the sensing areas in the circumferential direction of the rotation disc are homologized to at least three stages of different distances of the medical treating members; and
the distance controller drives the motor so that the distance detector detects an edge of the sensing areas among the above at least three edges when one among the above at least three stages of different distances of the medical treating members is selected.

2. The massager in accordance with claim 1, wherein
the distance between the medical treating members are varied from a largest state to a smallest state by caracoling the driving shaft;
two edges of the sensing areas are disposed on a same line passing the rotation center of the rotation disc; and
one of the above two edges of the sensing areas is homologized to the largest state of the distance between the medical treating members and the other of the above two edges of the sensing areas is homologized to the smallest state of the distance between the medical treating members.

3. The massager in accordance with claim 1, wherein
the optical detector is a transmission type photo-interrupter, the rotation disc is made of non-transparent material and arc shaped apertures are formed on the rotation disc as the sensing areas.

4. The massager in accordance with claim 1, wherein
the optical detector is a transmission type photo-interrupter; the rotation disc is made of transparent material and a surface of the rotation disc except the sensing areas are coated by non-transparent material.

5. The massager in accordance with claim 1, wherein
the optical detector is a reflection type photo-interrupter, the rotation disc is formed of a non-transparent material, and portions corresponding to the sensing areas are coated by a material having a reflectance higher than that of the non-transparent material.

6. The massager in accordance with claim 1, wherein
the rotation disc is rotated in a same direction at any time while the distance of the medical treating members is adjusted.

7. The massager in accordance with claim 6, wherein
the rotation disc is rotated in a same rotation speed at any time while the distance of the medical treating members is adjusted.

8. A massager comprising a pair of medical treating members, a motor for generating a driving force, a converting mechanism for converting rotation of a shaft of the motor to a motion for varying a distance between the medical treating members, a distance detector for detecting the distance between the medical treating members, and a distance controller for controlling the distance between the medical treating members among at least three stages, wherein
the distance detector is comprised of a rotation disc which is rotated with a driving shaft of the converting mechanism and has an arc shaped sensing area formed along a circle having a predetermined radius from a rotation center of the disc, and an optical detector provided for facing the rotation disc for detecting passage of edges of the sensing area in circumferential direction of the rotation of the rotation disc and for outputting detection signals corresponding to detection of the edges of the sensing areas;
the sensing area is formed so that an edge of the sensing areas in the circumferential direction is homologized to a predetermined distance of the medical treating members; and
the distance controller estimate rotation angle of the rotation disc based on a term after the distance detector detects the edge of the sensing areas homologized to the predetermined distance of the medical treating members, and drives the motor to stop when a predetermined term corresponding to a selected distance of the medical treating members selected has passed.

9. The massager in accordance with claim 8, wherein
the optical detector is a transmission type photo-interrupter, the rotation disc is made of non-transparent material and arc shaped apertures are formed on the rotation disc as the sensing areas.

10. The massager in accordance with claim 8, wherein
the optical detector is a transmission type photo-interrupter; the rotation disc is made of transparent material and a surface of the rotation disc except the sensing areas are coated by non-transparent material.

11. The massager in accordance with claim 8, wherein
the optical detector is a reflection type photo-interrupter, the rotation disc is formed of a non-transparent material, and portions corresponding to the sensing areas are coated by a material having a reflectance higher than that of the non-transparent material.
